(19) United States
(12) Patent Application Publication
(10) Pub. No.: US 2026/0346762 A1
(43) Pub. Date: Nov. 5, 2026

(54) CHILD CARRIER

(71) Applicant: WONDERLAND SWITZERLAND AG, Steinhausen (CH)

(72) Inventor: Xiaolong MO, Dongguan (CN)

(21) Appl. No.: 19/486,996

(22) PCT Filed: May 24, 2024
(86) PCT No.: PCT/EP2024/064425

§ 371 Date: Nov. 24, 2025

(30) Foreign Application Priority Data
May 24, 2023 (CN) 202310599728.X
Jul. 10, 2023 (CN) 202310842740.9
May 21, 2024 (CN) 202410636113.4

(51) Int. Cl. B60N 2/28; B60N 2/26

(52) U.S. Cl. CPC B60N 2/2821; B60N 2/269; B60N 2/2851; B60N 2/2869; B60N 2/2893

(57) ABSTRACT

The present application relates to a child carrier. The child carrier includes a base, a seat assembly rotatably disposed on the base, and a rotation angle adjustment mechanism. The rotation angle adjustment mechanism includes a limiting member disposed on the base and a pushing member disposed on the seat assembly. The pushing member is rotatable relative to the base along with the seat assembly. When the seat assembly is rotated such that the pushing member is located within a specified angle range, the limiting member drives the pushing member to rotate towards a position in a predetermined direction. When the pushing member is located in the predetermined direction, the limiting member locks the pushing member in the predetermined direction, thereby limiting the seat assembly to a preset use mode.

### CROSS-REFERENCE TO RELATED APPLICATIONS

This application is an U.S. national phase application under 35 U.S. C § 371 based upon international patent application No. PCT/EP2024/064425 filed on May 24, 2024, which itself claims priority to Chinese patent application No. 202310842740.9, filed on Jul. 10, 2023, Chinese patent application No. 202310599728.X, filed on May 24, 2023, and Chinese patent application No. 202410636113.4, filed on May 21, 2024, the disclosure of which are incorporated herein by reference in their entireties.

### TECHNICAL FIELD

The present application relates to the technical field of child products, and in particular, to a rotation angle adjustment mechanism, a fixing device and a child carrier.

### BACKGROUND

As people pay more and more attention to children's travel safety, child carriers have become an indispensable tool for children to travel. In order to be suitable for children of different ages or body sizes, child carriers are required to have at least a forward-facing use mode and a rearward-facing use mode. When a conventional child carrier is switched between different use modes, a seat thereof needs to be exactly rotated into place in order to lock the seat in the desired use mode. For example, when the conventional child carrier is switched from forward-facing use mode to rearward-facing use mode, the seat needs to be rotated to the position configured for the rearward-facing use mode to lock the sear in this use mode. Conventional child carriers have problems such as insufficient rotation angle or excessive rotation angle when switching between use modes, which reduces the user's operating experience. In addition, conventional child carriers also have the problem of poor headrest and side protection effects.

In addition, the child carrier currently on the market generally includes a base and a seat mounted on the base. A fixing device, such as an ISOFIX connector, is disposed on the base. The child carrier is fixed to a vehicle seat through the fixing device. However, the fixing device of the conventional child carrier is not convenient when performing unlocking, and the unlocking process is not smooth, and the problem of the error locking of the engaging member is easy to occur. In addition, the conventional fixing device has a complex structure, resulting in a high cost and inconvenience in transportation.

### SUMMARY

According to various embodiments of the present application, a rotation angle adjustment mechanism, a fixing device and a child carrier are provided.

According to an aspect of the present application, a rotation angle adjustment mechanism for a child carrier is provided. The child carrier includes a base and a seat assembly rotatably disposed on the base. The rotation angle adjustment mechanism includes a limiting member and a pushing member. The limiting member is disposed on the base. The pushing member is disposed on the seat assembly and is rotatable relative to the base along with the seat assembly. When the seat assembly is rotated such that the pushing member is located within a specified angle range, the limiting member drives the pushing member to rotate towards a position in a predetermined direction. When the pushing member is located in the predetermined direction, the limiting member is capable of cooperating with the pushing member to lock the pushing member in the predetermined direction, thereby limiting the seat assembly to a preset use mode.

In an embodiment, the limiting member is provided with a limiting recess. The pushing member has an engaging end. When the pushing member is located in the predetermined direction, the engaging end is engaged with the limiting recess.

In an embodiment, the rotation angle adjustment mechanism further includes an elastic reset member. The elastic reset member is adapted to provide elastic restoring force to the pushing member to cause the pushing member to push against the limiting member.

The limiting member is provided with a guide surface. The guide surface defines the specified angle range.

The pushing member is movably disposed on the seat assembly and is provided with a pushing surface adapted to cooperate with the guide surface. When the seat assembly is rotated such that the pushing surface is at least partially in contact with the guide surface, under the action of the elastic restoring force of the elastic reset member, the pushing surface cooperates with the guide surface, to cause the pushing member to rotate towards the position in the predetermined direction and be engaged with the limiting recess.

In an embodiment, the elastic reset member includes a compression spring.

In an embodiment, two pushing members are provided. The two pushing members are symmetrically disposed on the seat assembly. Two ends of the elastic reset member respectively abut against the two pushing members.

In an embodiment, the base is provided with an insertion hole. The seat assembly includes a seat body and a fixing cover. The fixing cover is at least partially inserted into the insertion hole and connected to the seat body, so that the seat body is rotatable around a rotation axis relative to the base together with the fixing cover. The pushing member is disposed on the fixing cover.

In an embodiment, the fixing cover is provided with a sliding groove, the pushing member is provided in the sliding groove and is slidable along the sliding groove. At least a portion of the pushing member is capable of extending out of the sliding groove to be engaged with the limiting member.

In an embodiment, one of the fixing cover and the pushing member is provided with a stroke groove, and another of the fixing cover and the pushing member is provided with a limiting protrusion. The limiting protrusion is inserted into the stroke groove to limit a moving stroke of the pushing member.

In an embodiment, the rotation angle adjustment mechanism further includes a fastener that at least partially extends through the stroke groove and is connected to the limiting protrusion.

In an embodiment, a moving direction of the pushing member is perpendicular to a rotation axis of the seat assembly. The pushing member or an extension line of the pushing member extends through the rotation axis.

In an embodiment, the limiting member further includes a slope surface. The slope surface is connected to a side of the guide surface away from the limiting recess and gently transitions to the guide surface. When the pushing member is in contact with the slope surface, the elastic reset member is in an energy storage state.

In an embodiment, a distance between any point on the slope surface and the rotation axis is less than a distance between a point on the limiting recess that is farthest from the rotation axis and the rotation axis.

In an embodiment, the limiting member is further provided with a lifting surface that enables the slope surface to smoothly transition to the guide surface. Two sides of the lifting surface are respectively connected to the slope surface and the guide surface.

In an embodiment, the limiting member is further provided with a driving surface. The driving surface and the guide surface are respectively disposed on two sides of the limiting recess, so that the pushing member is capable of withdrawing from the limiting recess along the driving surface.

In an embodiment, the driving surface and the guide surface are symmetrically disposed on the two sides of the limiting recess.

In an embodiment, the limiting member includes at least two limiting recesses. The number of the limiting recesses is an integer multiple of the number of the pushing members.

According to another aspect of the present application, a child carrier is provided, which includes a seat assembly, a base, and a rotation angle adjustment mechanism as described in any one of the above embodiments.

In an embodiment, the seat assembly includes a seat body and a buffer body disposed on the seat body. The buffer body includes a plurality of buffer blocks. A buffer gap is formed between two adjacent buffer blocks.

In an embodiment, the buffer gap includes a plurality of transverse gaps extending in a transverse direction and parallel to each other.

In an embodiment, the buffer gap includes a plurality of longitudinal gaps extending in a longitudinal direction and parallel to each other.

In an embodiment, the buffer gap includes: a first inclined gap extending in a first inclined direction at an angle to a transverse direction and a longitudinal direction; and a second inclined gap extending in a second inclined direction at an angle to the transverse direction and the longitudinal direction. The first inclined direction intersects with the second inclined direction.

In an embodiment, the buffer body further includes a connecting part. A plurality of the buffer blocks are connected together via the connecting part.

In an embodiment, the seat body includes a headrest part. The headrest part is provided with the buffer body.

In an embodiment, the seat body includes a headrest part and side parts located at two sides of the headrest part. The buffer body is disposed on each side part.

In an embodiment, the child carrier further includes a rotatable engaging mechanism. The rotatable engaging mechanism is disposed on the seat assembly. The base is provided with an engaging hole. The rotatable engaging mechanism is capable of being engaged with the engaging hole to lock the seat assembly in the preset use mode.

In an embodiment, the base includes a base body and a fixing device. The fixing device includes: a connecting assembly connected to the base body; an engagement mechanism including a first reset member, and an engaging element being pivotally connected to the connecting assembly, the engaging element being rotatable between an opened position and a closed position, the engaging element being capable of being engaged with an engaging rod on a vehicle seat when being in the closed position, the first reset member being disposed between the engaging element and the connecting assembly and being adapted to bias the engaging element to rotate toward the opened position; and a locking mechanism disposed on the connecting assembly. The locking mechanism is switchable between a locked state and an unlocked state. When the locking mechanism is in the locked state, the engaging element is locked in the closed position, and when the locking mechanism is in the unlocked state, the engaging element is unlocked in the closed position.

In an embodiment, the locking mechanism includes: a locking assembly disposed on the connecting assembly and movable between a first locked position and a first unlocked position, the locking assembly being capable of cooperating with the limiting part of the engaging element to lock the engaging element in the closed position when being in the first locked position, the locking assembly being separated from the limiting part when being in the first unlocked position; and a second reset member disposed between the connecting assembly and the locking assembly. The locking assembly is operable to move to the first unlocked position. The second reset member is adapted to bias the locking assembly to move the locking assembly towards the first locked position.

In an embodiment, the locking assembly includes: a driving member disposed at the connecting assembly and operable to move from the first unlocked position to the first locked position; and a limiting pin fixed to the driving member. The limiting pin is capable of abutting against the limiting part to lock the engaging element in the closed position.

In an embodiment, a rotation direction of the engaging element from the closed position to the opened position is taken as a first direction, and when the engaging element is located in the closed position, the limiting pin abuts against a side of the limiting part in the first direction.

In an embodiment, a rotation direction of the engaging element from the closed position to the opened position is taken as a first direction, the engaging element pivots relative to the connecting assembly with a pivot shaft as a rotation center. The engaging element has an engaging groove configured to be engaged with the engaging rod. Both the engaging groove and the limiting part are located at an edge of the engaging element. The engaging groove is located in the first direction of the limiting part.

In an embodiment, the fixing device further includes an indication assembly fixed on the driving member. The indication assembly includes at least a first indication identifier configured to indicate that the locking mechanism is in a locked state and a second indication identifier configured to indicate that the locking mechanism is in an unlocked state. The connecting assembly is provided with a display window allowing the first indication identifier or the second indication identifier to be exposed.

In an embodiment, the driving member is provided with a first safety locking part, the connecting assembly is provided with a second safety locking part. The first safety locking part and the second safety locking part are capable of separably pushing against or engaging with each other to prevent the driving member from moving towards the first unlocked position.

In an embodiment, the connecting assembly includes: a connecting housing having an engaging opening, at least a portion of the engaging element extending out of the engaging opening to be engaged with an engaging rod on the vehicle seat; and a reinforcing member fixed in the connecting housing. The engaging element is pivotally connected to the reinforcing member. The first reset member is disposed between the reinforcing member and the engaging element. The locking mechanism at least partially extends out of the connecting housing so as to be operated.

According to another aspect of the present application, a fixing device for a child carrier is provided. The child carrier includes a base and a seat assembly mounted on the base. The base includes a base body and the fixing device. The fixing device includes: a connecting assembly connected to the base body; an engagement mechanism including a first reset member, and an engaging element being pivotally connected to the connecting assembly, the engaging element being rotatable between an opened position and a closed position, the engaging element being capable of being engaged with an engaging rod on the vehicle seat when being in the closed position, the first reset member being disposed between the engaging element and the connecting assembly and being adapted to bias the engaging element to rotate toward the opened position; and a locking mechanism disposed on the connecting assembly. The locking mechanism is switchable between a locked state and an unlocked state. When the locking mechanism is in the locked state, the engaging element is locked in the closed position, and when the locking mechanism is in the unlocked state, the engaging element is unlocked in the closed position.

In an embodiment, the locking mechanism includes: a locking assembly disposed on the connecting assembly and movable between a first locked position and a first unlocked position, the locking assembly being capable of cooperating with a limiting part of the engaging element to lock the engaging element in the closed position when being in the first locked position, the locking assembly being separated from the limiting part when being in the first unlocked position; and a second reset member disposed between the connecting assembly and the locking assembly. The locking assembly is operable to move to the first unlocked position. The second reset member is adapted to bias the locking assembly to move the locking assembly towards the first locked position.

In an embodiment, the locking assembly includes: a driving member disposed at the connecting assembly and operable to move from the first unlocked position to the first locked position; and a limiting pin fixed to the driving member. The limiting pin is capable of abutting against the limiting part to lock the engaging element in the closed position.

In an embodiment, a rotation direction of the engaging element from the closed position to the opened position is taken as a first direction, and when the engaging element is located in the closed position, the limiting pin abuts against a side of the limiting part in the first direction.

In an embodiment, a rotation direction of the engaging element from the closed position to the opened position is taken as a first direction, the engaging element pivots relative to the connecting assembly with a pivot shaft as a rotation center. The engaging element has an engaging groove configured to be engaged with the engaging rod. Both the engaging groove and the limiting part are located at an edge of the engaging element. The engaging groove is located in the first direction of the limiting part.

In an embodiment, the first reset member includes a torsion spring. The torsion spring is sleeved on the pivot shaft, and has two ends abutting against the engaging element and the connecting assembly respectively.

In an embodiment, the fixing device further includes an indication assembly fixed on the driving member. The indication assembly includes at least a first indication identifier configured to indicate that the locking mechanism is in a locked state and a second indication identifier configured to indicate that the locking mechanism is in an unlocked state. The connecting assembly is provided with a display window allowing the first indication identifier or the second indication identifier to be exposed.

In an embodiment, the driving member is provided with a first safety locking part, the connecting assembly is provided with a second safety locking part. The first safety locking part and the second safety locking part are capable of separably pushing against or engaging with each other to prevent the driving member from moving towards the first unlocked position.

In an embodiment, the locking mechanism further includes a third reset member. The third reset member is disposed between the driving member and the first safety locking part, and is configured to provide an elastic force to engage the first safety locking part with the second safety locking part or push the first safety locking part against the second safety locking part.

In an embodiment, the first safety locking part includes a safety pin slidably disposed on the driving member, and the second safety locking part includes a retaining pin fixed to the connecting assembly.

In an embodiment, the third reset member includes a torsion spring. Two ends of the torsion spring are respectively a coupling end and a deformation end. The coupling end is connected to the safety pin. The deformation end is capable of abutting against the driving member to provide an elastic force to engage the first safety locking part with the second safety locking part or push the first safety locking part against the second safety locking part. A portion of the torsion spring located between the coupling end and the deformation end is fixed to the driving member.

In an embodiment, the driving member is provided with a sliding hole extending in a protruding direction of the retaining pin. The safety pin is slidably disposed in the sliding hole. The sliding hole has a first end and a second end. When the safety pin slides to the first end, the safety pin abuts against a side of the retaining pin facing the engaging element. When the safety pin slides to the second end, the safety pin is separated from the retaining pin.

In an embodiment, the locking mechanism further includes: a safety unlocking member movably disposed on the connecting assembly. The safety unlocking member is switchable between a second locked position and a second unlocked position. The safety unlocking member is operable to move to the second unlocked position and drive the safety pin to slide and separate from the retaining pin.

In an embodiment, the safety unlocking member is slidably disposed on the connecting assembly and has an inclined surface or an arc-shaped surface configured to push the safety pin to slide.

In an embodiment, the locking mechanism further includes: a fourth reset member disposed between the safety unlocking member and the connecting assembly. The fourth reset member is adapted to bias the safety unlocking member to move toward the second locked position.

In an embodiment, one end of the safety unlocking member extends out of the connecting assembly to be operated, another end of the safety unlocking member has a fork-shaped structure and has two fork legs. The retaining pin is located at between the two fork legs.

In an embodiment, the two fork legs are each provided with an inclined surface or an arc-shaped surface configured to push the safety pin to slide.

In an embodiment, when the locking mechanism is in the locked state and the safety unlocking member is not operated, there is an idle stroke between the driving member and the retaining pin. When the driving member is operated to move within the idle stroke, the limiting pin remain pushing against the limiting part, and the safety unlocking member is spaced apart from the safety pin.

In an embodiment, the connecting assembly includes: a connecting housing having an engaging opening, at least a portion of the engaging element extending out of the engaging opening to be engaged with an engaging rod on the vehicle seat; and a reinforcing member fixed in the connecting housing. The engaging element is pivotally connected to the reinforcing member. The first reset member is disposed between the reinforcing member and the engaging element. The locking mechanism at least partially extends out of the connecting housing so as to be operated.

According to yet another aspect of the present application, a base of a child carrier is provided. The base includes a base body and a fixing device as described in any of the above embodiments. The fixing device is disposed on the base body.

According to yet another aspect of the present application, a child carrier is provided. The child carrier includes the base as described above and a seat assembly mounted on the base.

### BRIEF DESCRIPTION OF THE DRAWINGS

FIG. 1 is a schematic view of a child carrier in a forward-facing use mode according to some embodiments of the present application.

FIG. 2 is a schematic view of a child carrier in a rearward-facing use mode according to some embodiments of the present application.

FIG. 3 is a cross-sectional view of a child carrier in a forward-facing use mode according to some embodiments of the present application.

FIG. 4 is a partial enlarged view of a frame A shown in FIG. 3, showing an engagement of a rotatable engaging mechanism with a forward positioning hole of a base.

FIG. 5 is a view showing a state in which an engaging member of the rotatable engaging mechanism is in a retracted state.

FIG. 6 is a cross-sectional view of a child carrier in a rearward-facing use mode according to some embodiments of the present application.

FIG. 7 is a partial enlarged view of a frame B shown in FIG. 6, showing an engagement of the rotatable engaging mechanism with a rearward positioning hole of a base.

FIG. 8 is a schematic view of a child carrier according to some embodiments of the present application, in which the base is omitted and an upper surface of a seat assembly are partially omitted to illustrate an engaging fixing member of the rotatable engaging mechanism.

FIG. 9 is a partial enlarged view of a frame C shown in FIG. 8.

FIG. 10 is a schematic view of a child carrier according to some embodiments of the present application, with the base partially omitted and a seat assembly in a forward-facing use mode, including an enlarged view of a rotation angle adjustment mechanism of the child carrier.

FIG. 11 is a schematic view of the child carrier shown in FIG. 10 when being rotated such that a pushing member is located within a specified angle range, including an enlarged view of the rotation angle adjustment mechanism of the child carrier.

FIG. 12 is a schematic view of the child carrier shown in FIG. 11 when being rotated such that the pushing member is in a predetermined direction, with the seat assembly in a leftward-facing use mode, including an enlarged view of the rotation angle adjustment mechanism of the child carrier.

FIG. 13 a schematic view of the child carrier shown in FIG. 12 when being rotated such that the pushing member is located within a specified angle range, including an enlarged view of the rotation angle adjustment mechanism of the child carrier.

FIG. 14 is a schematic view of the child carrier shown in FIG. 13 when being rotated such that the pushing member is in a predetermined direction, with the seat assembly in the rearward-facing mode, including an enlarged view of the rotation angle adjustment mechanism of the child carrier.

FIG. 15 is an exploded view of the child carrier in FIG. 10.

FIG. 16 is an exploded view of a seat assembly and a rotation angle adjustment mechanism of the child carrier according to some embodiments of the present application.

FIG. 17 is an exploded view of a base of a child carrier according to some embodiments of the present application.

FIG. 18 is a schematic view of a child carrier according to some embodiments of the present application.

FIG. 19 is a schematic view of a headrest rear buffer body according to some embodiments of the present application.

FIG. 20 is a schematic view of a headrest right buffer body according to some embodiments of the present application.

FIG. 21 is a schematic view of a headrest left buffer body according to some embodiments of the present application.

FIG. 22 is a schematic view of a right wing buffer body according to some embodiments of the present application.

FIG. 23 is a schematic view of a left wing buffer body according to some embodiments of the present application.

FIG. 24 is a schematic view of a base according to some embodiments of the present application, with a telescopic rod in a retracted state, including an enlarged view of a fixing device of the base.

FIG. 25 is a schematic view of a base according to some embodiments of the present application, with a telescopic rod in an extended state, including an enlarged view of a fixing device of the base.

FIG. 26 is a longitudinal cross-sectional view of the base shown in FIG. 25, with a locking mechanism in a locked state, including an enlarged view of the fixing device of the base.

FIG. 27 is a longitudinal cross-sectional view of the base shown in FIG. 25, with a locking mechanism in an unlocked state, including an enlarged view of the fixing device of the base.

FIG. 28 is a cross-sectional view taken along line M-M of the fixing device of the base shown in FIG. 26.

FIG. 29 is a cross-sectional view taken along line N-N of the fixing device of the base shown in FIG. 27.

FIG. 30 is a schematic view of the base shown in FIG. 25 from another perspective, with a locking mechanism in a locked state.

FIG. 31 is a schematic view of the base shown in FIG. 30 with a first housing omitted, including an enlarged view of the fixing device.

FIG. 32 is a schematic view of the base shown in FIG. 31 from another perspective, with a first housing omitted, including an enlarged view of the fixing device.

FIG. 33 is a schematic view of the base shown in FIG. 30 with a first housing and a reinforcing member omitted, including an enlarged view of the fixing device.

FIG. 34 is a schematic view of the base shown in FIG. 33 from another perspective, with the first housing and the reinforcing member omitted, including an enlarged view of the fixing device.

FIG. 35 is a schematic view of the structure of the base shown in FIG. 25 from another perspective, with a locking mechanism is in an unlocked state.

FIG. 36 is a schematic view of the base shown in FIG. 35, with a first housing omitted, including an enlarged view of a fixing device.

FIG. 37 is a schematic view of the base shown in FIG. 36 from another perspective, with the first housing omitted, including an enlarged view of the fixing device.

FIG. 38 is a schematic view of the base shown in FIG. 35 with a first housing and a reinforcing member omitted, including an enlarged diagram of the fixing device.

FIG. 39 is a schematic view of the base shown in FIG. 38 from another perspective, with the first housing and the reinforcing member omitted, including an enlarged view of the fixing device.

FIG. 40 is a partial exploded view of the fixing device and the telescopic rod of the base shown in FIG. 25.

FIG. 41 is an enlarged view of a third reset member of the fixing device shown in FIG. 40.

### ILLUSTRATION FOR REFERENCE NUMERALS

1, Child carriers; 100, Seat assembly;
110, rotatable engaging mechanism;
111, engaging member; 112, pulling member; 1121, first pulling member; 1122, second pulling member; 113, engaging reset member; 114, engaging fixing member; 115, screw, 116, unlocking operating member;
120, Rotation angle adjustment mechanism;
121, limiting member; 1211, limiting recess; 12111, arc-shaped surface of limiting recess; 1212, guide surface; 12121, starting side; 1213, driving surface; 1214, slope surface; 1215, lifting surface;
122, pushing member; 1221, engaging end; 1222, connecting end; 1223, connecting protrusion; 1224, stroke groove; 1225, pushing surface;
123, Elastic reset member; 124, Fastener;
130, seat body; 131, headrest part; 132, side part;
140, fixing cover; 143, sliding groove; 1431, open end; 144, rib; 145, limiting protrusion;
150, buffer body; 150a, headrest rear buffer body; 150b, headrest right buffer body; 150c, headrest left buffer body; 150d, right wing buffer body; 150e, left wing buffer body; 151, buffer block; 152, connecting part; 153, back surface; 154, front surface; 155, buffer gap; 155a, transverse gap;
200, base; 201, positioning hole; 2011, forward positioning hole; 2012, rearward positioning hole; 210, upper base cover; 211, insertion hole; 220, lower base cover; 240, base body; 250, fixing device; 260, telescopic unlocking button; 270, telescopic rod;
1000, connecting assembly; 1100, connecting housing; 1110, first housing; 1111, first side; 1112, second side; 1113, first groove; 1120, second housing; 11210, display window; 11210a, first display window; 11210b, second display window; 11220, operation port; 11230, shielding member; 1200, reinforcing member; 1210, first reinforcing plate; 12110, first elongated groove; 1220, second reinforcing plate; 12210, second elongated groove; 1230, mounting cavity; 1240, second groove; 125, engaging opening;
2000, engagement mechanism; 2100, engaging element; 2110, engaging groove; 2120, limiting part; 21210, second matching part; 2200, first reset member; 2210, end; 2220, first collar; 2300, pivot shaft;
300, locking mechanism; 310, locking assembly; 311, driving member; 3112, first operating part; 3113, mounting groove; 3113a, first groove wall; 3113b, second groove wall; 3113c, first mounting protrusion; 3114, sliding hole; 3114a, first end; 3114b, second end; 3115, slot; 3111, first matching part; 312, limiting pin; 320, second reset member; 330, third reset member; 331, coupling end; 332, deformation end; 333, second collar; 340, safety unlocking member; 341, unlocking member body; 342, second operating part; 343, fork leg; 3431, inclined surface or arc-shaped surface; 350, fourth reset member; 361, positioning pin; 362, safety pin; 363, retaining pin; 364, mounting pin;
400, Indication assembly; 410, First indication identifier; 420, Second indication identifier;
Dp1, first predetermined direction; Dp2, second predetermined direction; Dp3, third predetermined direction; Dp4, fourth predetermined direction; D1, first direction; D2, second direction; S, rotation axis; F, pushing force; F1, first force component; F2, second force component; D3, third direction; L, idle stroke; D4, fourth direction; D5, fifth direction.

### DETAILED DESCRIPTION

In order to make the above objects, features, and advantages of the present application more obvious and understandable, a detailed description of the specific embodiments of the present application will be provided below in conjunction with the attached drawings. Many specific details are set forth in the following description to facilitate a thorough understanding of this application. However, the present application can be implemented in many other ways different from those described herein, and those skilled in the art can make similar improvements without departing from the spirit of the present application. Therefore, the present application is not limited by the specific embodiments disclosed below.

In the description of the present application, it should be understood that orientations or positional relationships indicated by the terms “center”, “longitudinal”, “transverse”, “length”, “width”, “thickness”, “up”, “down”, “front”, “back”, “left”, “right”, “vertical”, “horizontal”, “top”, “bottom”, “inside”, “outside”, “clockwise”, “counterclockwise”, “axial”, “radial”, “circumferential” and the like are based on the orientations or positional relationships shown in the accompanying drawings, and are only for the convenience of describing the present application and simplifying the description, and do not indicate or imply that the referred device or element must have a specific orientation, be constructed and operated in a specific orientation, and therefore should not be understood as a limitation on the present application.

In addition, the terms “first” and “second” are used for descriptive purposes only and should not be understood as indicating or implying relative importance or implicitly indicating the number of the indicated technical features. Therefore, the features defined by “first” and “second” may explicitly or implicitly include at least one of the features. In the description of this application, the “plurality” includes at least two, such as two, three, etc., unless otherwise clearly and specifically defined.

In this application, unless otherwise clearly specified and limited, the terms “mounting”, “coupling”, “connection”, “fixation” and the like should be understood in a broad sense, for example, which can be a fixed connection, a detachable connection, or integrally formed; or which can be a mechanical connection or an electrical connection; or, which can be a direct connection or an indirect connection through an intermediate medium; or, which can be the internal connection of two elements or the interaction relationship between two elements, unless otherwise clearly defined. For one of ordinary skill in this art, the specific meanings of the above terms in this application can be understood according to specific circumstances.

In the present application, unless otherwise clearly specified and limited, a first feature being “above” or “below” a second feature may mean that the first feature and the second feature are in direct contact, or the first feature and the second feature are in indirect contact through an intermediate medium. Moreover, a first feature being “over”, “above”, and “on the top of” a second feature may mean that the first feature is directly above or obliquely above the second feature, or simply means that the first feature is higher in level than the second feature. A first feature being “under”, “below”, and “beneath” a second feature may mean that the first feature is directly below or obliquely below the second feature, or simply means that the first feature is lower in level than the second feature.

It should be noted that when an element is referred to as being “fixed to” or “disposed on” another element, it can be directly on the other element or an intermediate element may also be present. When an element is referred to as being “connected” to another element, it can be directly connected to the other element or there may also be an intermediate element. The term “vertical”, “horizontal”, “upper”, “lower”, “left”, “right” or similar expressions used herein, is for illustrative purposes only and do not represent the unique implementations.

Unless otherwise defined, all technical and scientific terms used herein have the same meaning as commonly understood by one of ordinary skill in the technical field to which this application belongs. The terms used herein in the description of the present application are for the purpose of describing specific implementations only and is not intended to limit the present application. As used herein, the term “and/or” includes any and all combinations of one or more of the associated listed items.

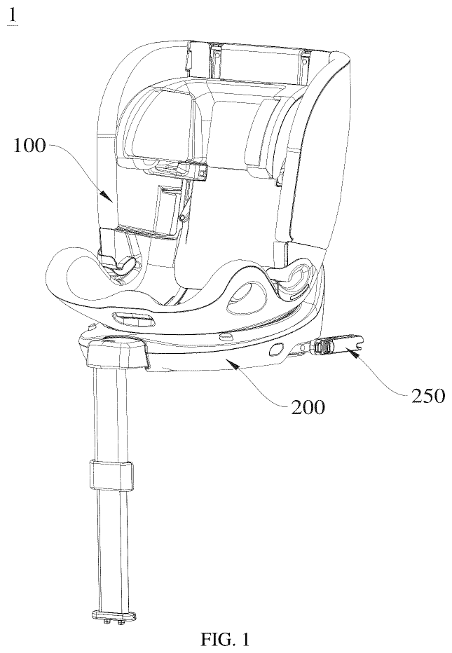

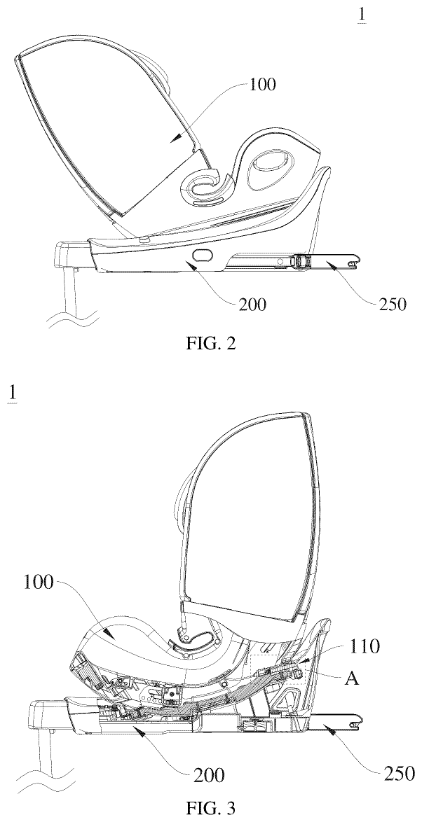

FIGS. 1 and 2 are schematic views showing a child carrier 1 in different use modes.

Some embodiments of the present application provide a child carrier. The child carrier may be, for example, a child safety seat, a stroller, etc. The child carrier as a child safety seat will be described below.

As shown in FIGS. 1 to 2, the child carrier 1 includes a seat assembly 100 and a base 200. The seat assembly 100 is disposed on the base 200 and is rotatable relative to the base 200. The seat assembly 100 of the child carrier 1 has four use modes: a forward-facing use mode (as shown in FIG. 1), in which the seat assembly 100 faces a direction of forward motion of the child carrier 1; a rearward-facing use mode (as shown in FIG. 2), in which the seat assembly 100 faces away from the direction of forward motion of the child carrier 1; a leftward-facing use mode (not shown), in which the seat assembly 100 faces the left side of the child carrier 1 in the direction of forward motion of the child carrier 1; and a rightward-facing use mode (not shown), in which the seat assembly 100 faces the right side of the child carrier 1 in the direction of forward motion of the child carrier 1. In the case of the child safety seat, the forward-facing use mode and the rearward-facing use mode can be set when a vehicle is moving forward, and the leftward-facing use mode and the rightward-facing use mode can be set when the vehicle is parked, thereby making the child safety seat easier for a child to get on and off the child carrier 1, but which is not limited thereto in this application. In some other embodiments, the child carrier may only have a forward-facing use mode and a rearward-facing use mode. The child carrier 1 of the present application can be switched between different use modes by rotating its seat assembly 100 relative to the base 200.

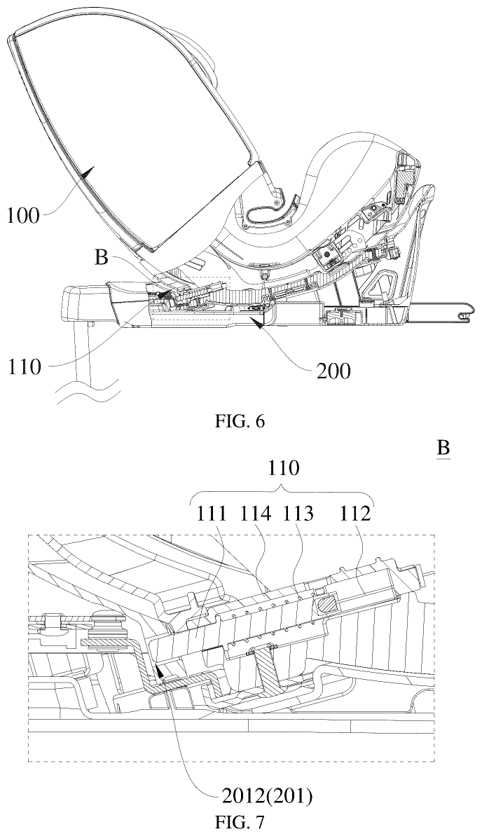

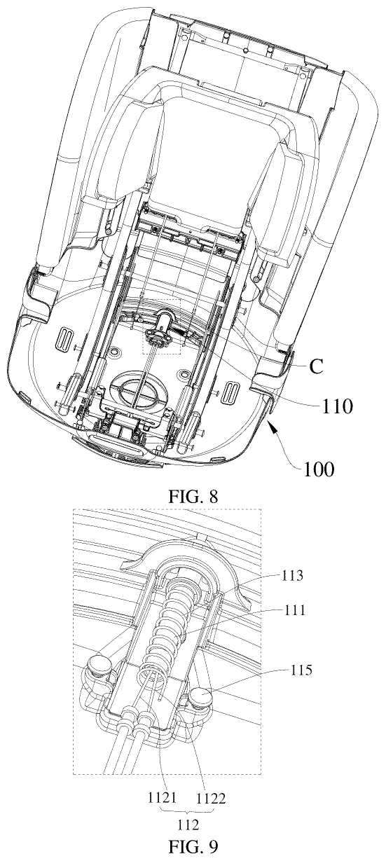

FIGS. 3 to 5 show a rotatable engaging mechanism of the child carrier 1 when being in the forward-facing use mode, FIGS. 6 and 7 show the rotatable engaging mechanism of the child carrier 1 when being in the rearward-facing use mode, and FIGS. 8 to 10 respectively show an engaging fixing member and other internal components of the rotatable engaging mechanism.

In some embodiments, as shown in FIGS. 3 to 7, the child carrier 1 of the present application includes a rotatable engaging mechanism 110. The rotatable engaging mechanism 110 is disposed on the seat assembly 100. The rotatable engaging mechanism 110 can be engaged with and be fixed into a corresponding positioning hole 201 of the base 200. The positioning hole 201 at least includes a forward positioning hole 2011 and a rearward positioning hole 2012, so that the seat assembly at least can be locked in the forward-facing use mode or the rearward-facing use mode. When the seat assembly 100 is in the forward-facing use mode, the rotating engagement mechanism 110 is engaged with the forward positioning hole 2011. When the seat assembly 100 is in the rearward-facing use mode, the rotating engagement mechanism 110 is engaged with the rearward positioning hole 2012. In some other embodiments, other positioning holes 201 may also be disposed on the base 200, such as a leftward positioning hole (not shown) and a rightward positioning hole (not shown), so that the seat assembly 100 can be locked in other use modes other than the forward-facing use mode and the rearward-facing use mode.

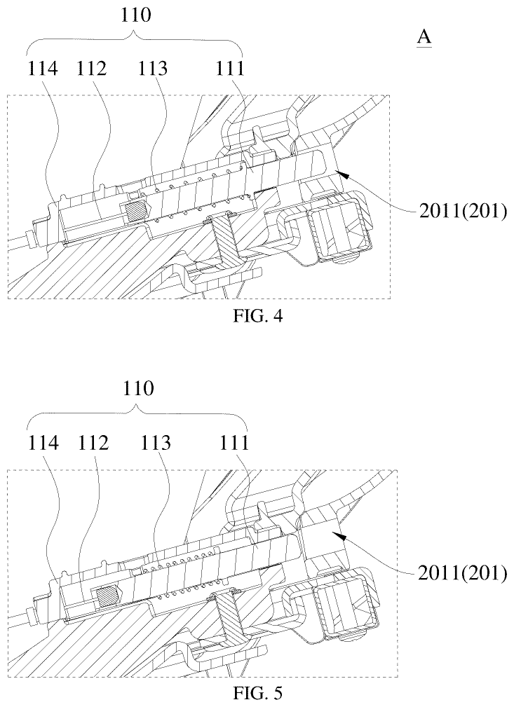

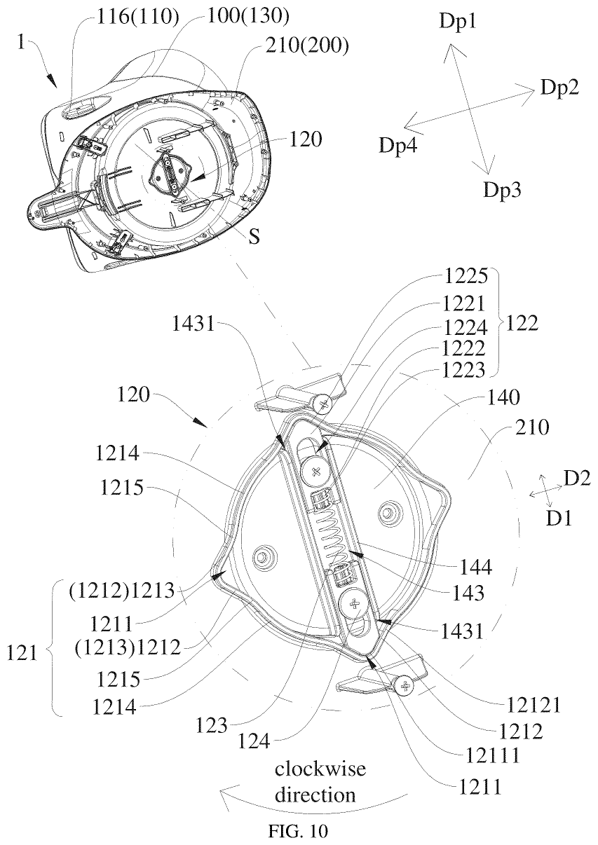

As shown in FIG. 4, the rotatable engaging mechanism 110 includes an unlocking operating member 116 (see FIG. 10), an engaging member 111, a pulling member 112, and an engaging fixing member 114. The engaging fixing member 114 is fixedly disposed in the seat assembly 100. Referring to FIG. 9, the engaging fixing member 114 can be fixedly disposed on the seat assembly 100 by screws 115 located on both sides of the engaging fixing member 114, so as to rotate with the seat assembly 100 relative to the base 200. One end of the engaging fixing member 114 is open, and the engaging member 111 is disposed in the engaging fixing member 114 and can slide in the engaging fixing member 114, so that a first end of the engaging member 111 can extend from the open end of the engaging fixing member 114, to be engaged with the forward positioning hole 2011 or the rearward positioning hole 2012.

As shown in FIG. 4, one end of the pulling member 112 is connected to a second end of the engaging member 111, and another end of the pulling member 112 is connected to the unlocking operating member 116 (refer to FIG. 10). For example, the pulling member 112 may be a steel wire, and the unlocking operating member 116 may be an unlocking button, but which are not limited thereto in the present application. In some embodiments, referring to FIG. 10, unlocking operating members 116 may be disposed on two sides of the child carrier 1 (for example, the left side and the right side of the child carrier 1), and the pulling member 112 of the rotatable engaging mechanism 110 may include a first pulling member 1121 and a second pulling member 1122. First ends of the first pulling member 1121 and the second pulling member 1122 are connected to the corresponding unlocking operating member 116, and second ends of the first pulling member 1121 and the second pulling member 1122 are connected to the engaging member 111, so that when any of the unlocking operating members 116 on the two sides of the child carrier 1 is operated, the engaging member 111 can be driven to achieve synchronous adjustment. In other embodiments, one unlocking operating member 116 may be disposed on only one side of the child carrier 1 (e.g., the left side or the right side of the child carrier 1), which is not limited in the present application.

In addition, as shown in FIGS. 4, 7 and 9, the rotatable engaging mechanism 110 may further include an engaging reset member 113. The engaging reset member 113 is disposed between the engaging fixing member 114 and the engaging member 111, and constantly provides a force to drive the first end of the engaging member 111 to extend out of the engaging fixing member 114, so that when the seat body 100 is rotated to the position (i.e., rotated to the position for forward-facing use mode or rearward-facing use mode) and the unlocking operating member 116 (see FIG. 10) is not operated, the engaging member 111 is always inserted into the corresponding positioning hole 201 to be engaged into this positioning hole 201. The engaging reset member 113 is, for example, a compression spring, but which is not limited thereto in the present application.

With the above configuration, referring to FIG. 4, when the child carrier 1 is in the forward-facing use mode, the first end of the engaging member 111 remains extending out of the engaging fixing member 114 under the action of the engaging reset member 113, and then extends out of a housing of a seat body 130 of the seat assembly 100, to be engaged with the forward positioning hole 2011 of the base 200, so that the seat assembly 100 is locked relative to the base 200 and is not rotatable. When it is necessary to switch the child carrier 1 from the forward-facing use mode to the rearward-facing use mode, the unlocking operating member 116 is operated to drive the pulling member 112, and then the extended end of the engaging member 111 is retracted into the engaging fixing member 114 under the pulling force of the pulling member 112 (see FIG. 5), thereby allowing the seat assembly 100 to be rotated relative to the base 200 to be in other use modes, such as the rearward-facing use mode. During the rotation process, due to the restriction of the inner housing of the base 200 on the engaging member 111, as the seat assembly 100 rotates, the engaging member 111 always remains in a retracted state until it faces the rearward positioning hole 2012, and then under the action of the engaging reset member 113, extends out of the engaging fixing member 114 again to be engaged with the rearward positioning hole 2012, thereby locking the seat assembly 100 in the rearward-facing use mode.

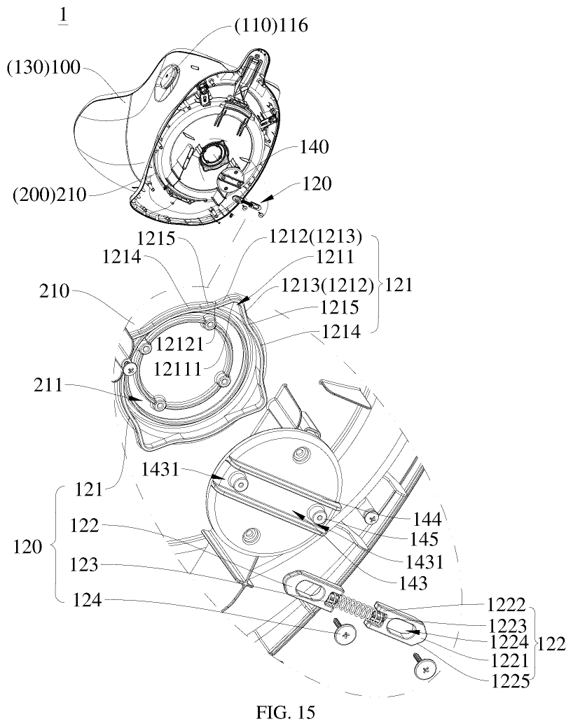

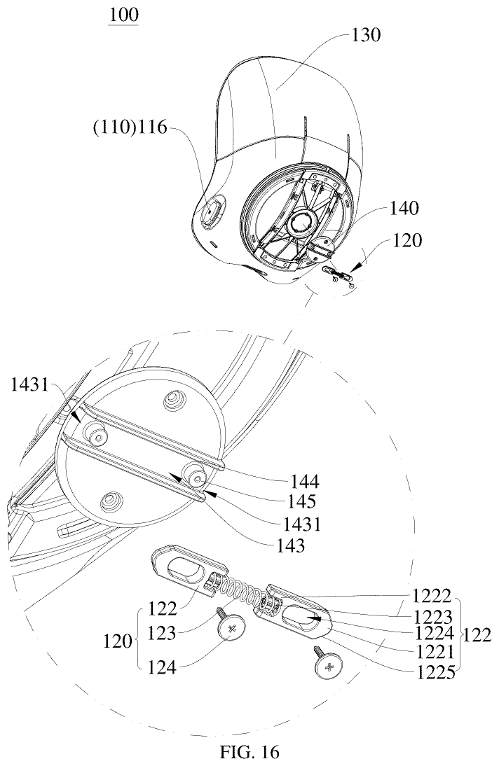

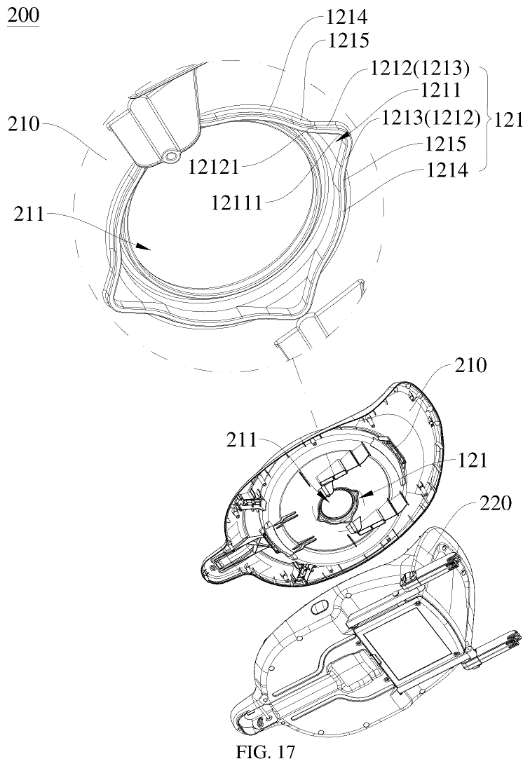

FIGS. 10 to 14 show the child carrier 1 and its rotation angle adjustment mechanism during the adjustment from the forward-facing use mode to the rearward-facing use mode. FIG. 15 shows an exploded view of the child carrier 1, including an enlarged view of its rotation angle adjustment mechanism. FIG. 16 shows an exploded view of the seat assembly 100, including an enlarged view of its rotation angle adjustment mechanism. FIG. 17 is an exploded view of the base 200, including an enlarged view of a limiting member 121.

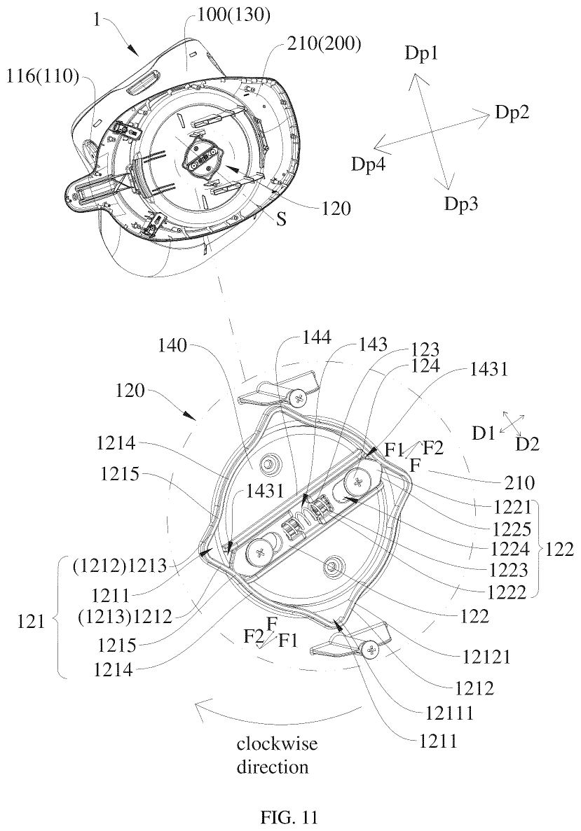

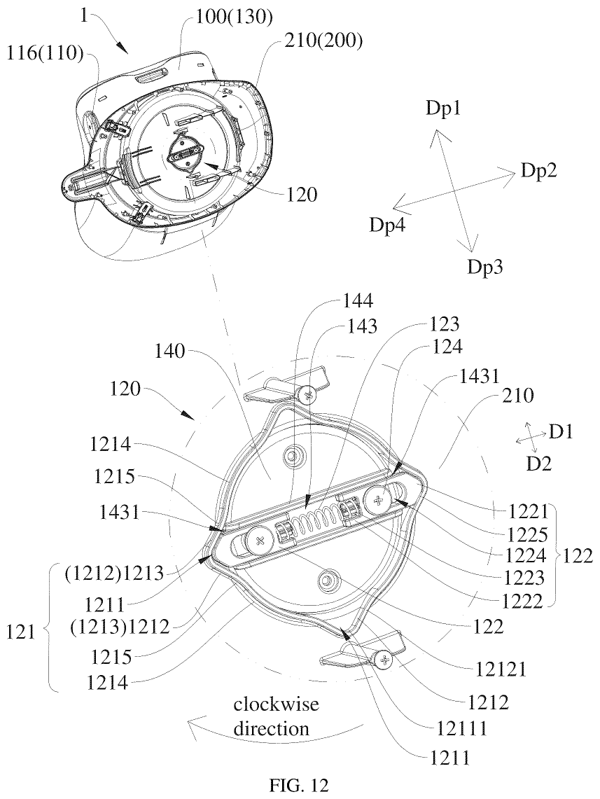

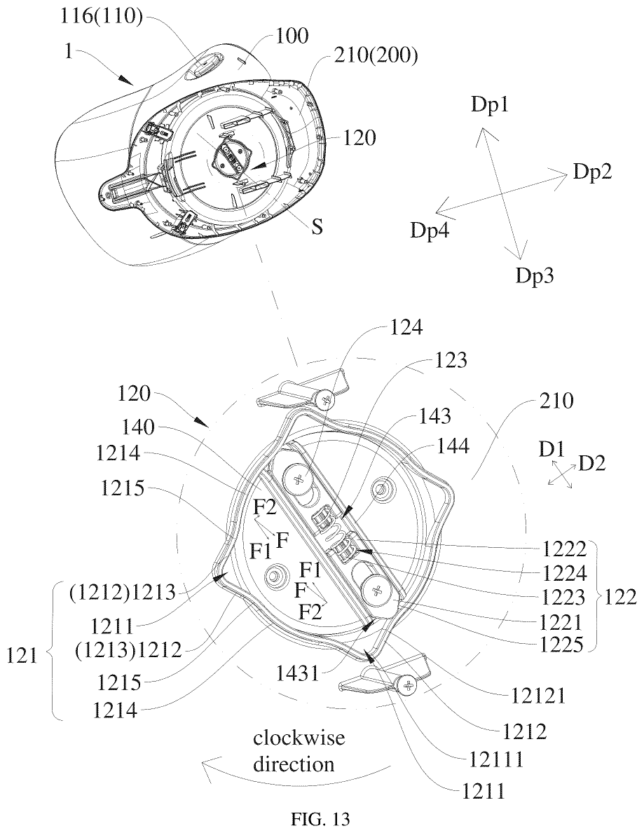

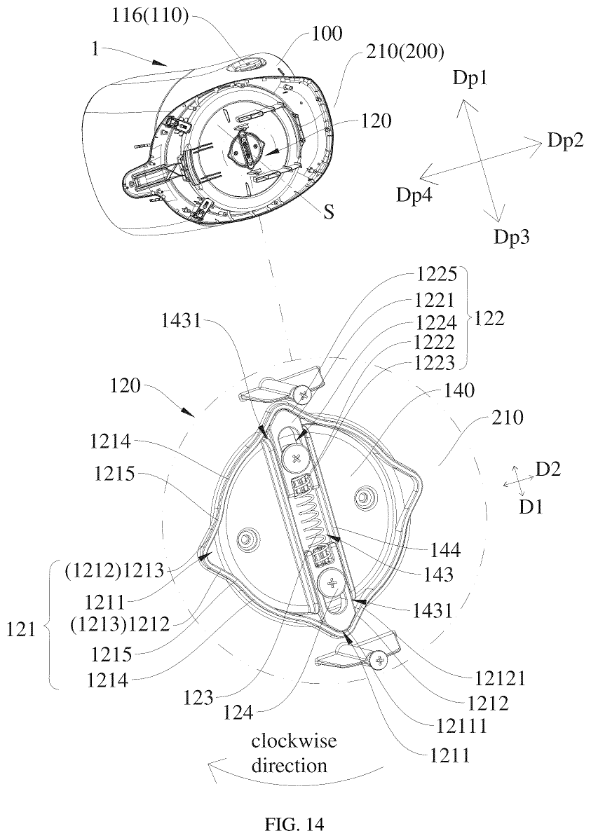

In some embodiments, as shown in FIGS. 10 to 14, the child carrier 1 further includes a rotation angle adjustment mechanism 120. The rotation angle adjustment mechanism 120 includes the limiting member 121, a pushing member 122, and an elastic reset member 123. The limiting member 121 is disposed on the base 200. The pushing member 122 is disposed on the seat assembly 100 (for example, a fixing cover 140 of the seat assembly 100) and is rotatable with the seat assembly 100 relative to the base 200. Referring to FIGS. 11 and 13, when the seat assembly 100 is rotated such that the pushing member 122 is located within a specified angle range, the limiting member 121 drives the pushing member 122 to rotate towards a position in a predetermined direction. When the pushing member 122 is located in the predetermined direction, the limiting member 121 can cooperate with the pushing member 122 to limit the pushing member 122 in the predetermined direction, thereby limiting the seat assembly 100 in a preset use mode (for example, forward-facing use mode, rearward-facing use mode, leftward-facing use mode, or rightward-facing use mode). The limiting member 121 is configured to limit the pushing member 122 to be within the above specified angle range. The predetermined directions include, for example, a first predetermined direction Dp1 corresponding to the forward-facing use mode, a second predetermined direction Dp2 corresponding to the leftward-facing use mode, a third predetermined direction Dp3 corresponding to the rearward-facing use mode, and a fourth predetermined direction Dp4 corresponding to the rightward-facing use mode, but which is not limited thereto in the application. The first predetermined direction and the third predetermined direction are parallel to each other, and the second predetermined direction and the fourth predetermined direction are parallel to each other. Referring to FIGS. 12 and 14, when the pushing member 122 is located in a predetermined direction (Dp2 or Dp3), the pushing member 122 can be limited in the predetermined direction (Dp2 or Dp3) by the limiting member 121.

In an embodiment, the seat assembly 100 is lockable in at least some of the predetermined directions relative to the base 200. For example, when the pushing member 122 is in the first predetermined direction or the third predetermined direction (that is, the seat assembly 100 is in the forward-facing use mode or the rearward-facing use mode), the engaging member 111 of the rotatable engaging mechanism 110 can be engaged with the corresponding positioning hole (or referred to as engaging hole) 201 of the base 200, so that the seat assembly 100 is locked at the rotation angle corresponding to the forward-facing or rearward-facing use mode, thereby locking the seat assembly 100 in the forward-facing or rearward-facing use mode. In this case, when the unlocking operating member 116 of the rotatable engaging mechanism 110 is operated to cause the engaging member 111 to be withdrawn from the corresponding positioning hole 201, and an external force is applied to the pushing member 122 (or the seat assembly 100), the pushing member 122 can drive the seat assembly 100 to rotate relative to the base 200. With such configuration, the seat assembly 100 can be prevented from accidentally rotating while the vehicle or the child carrier 1 is traveling. When the pushing member 122 is in the second predetermined direction or the fourth predetermined direction (that is, when the seat assembly 100 is in the leftward-facing or the rightward-facing use mode), the engaging member 111 of the rotatable engaging mechanism 110 may be or may be not engaged with the corresponding positioning hole 201, which is not limited in this application. In this embodiment, when the pushing member 122 is located in the predetermined direction (Dp1, Dp2, Dp3 or Dp4), and when the engaging member 111 is not engaged with the positioning hole 201, the limiting member 121 can still limit the pushing member 122 in the predetermined direction (Dp1, Dp2, Dp3 or Dp4). In this case, when the external force is applied to the pushing member 122 (or the seat assembly 100) to cause the pushing member 122 (or the seat assembly 100) to rotate, the pushing member 122 and hence the seat assembly 100 can rotate relative to the base 200.

In some embodiments, as shown in FIGS. 10 to 14 and FIG. 17, the base 200 includes an upper base cover 210 and a lower base cover 220 that is detachably connected to the upper base cover 210. The base 200 is provided with an insertion hole 211. The insertion hole 211 extends through the upper base cover 210 and extends in a direction of a rotation axis S. At least a portion of the seat assembly 100 is inserted into the insertion hole 211 and can rotate about the rotation axis S. In this embodiment, the seat assembly 100 includes a seat body 130 and a fixing cover 140. The seat body 130 is rotatably connected to the base 200. The fixing cover 140 is detachably connected to the seat body 130. The fixing cover 140 is at least partially inserted into the insertion hole 211, so that the seat body 130 can synchronically drive the fixing cover 140 to rotates about the rotation axis S relative to the base 200. The fixing cover 140 has a substantially circular cross-section. The pushing member 122 is disposed on the fixing cover 140, so that when the seat body 130 rotates, the pushing member 122 can be driven by the fixing cover 140 to rotate relative to the base 200. In this embodiment, through the fixing cover 140 disposed on the seat body 130, the pushing member 122 can be driven to rotate when the seat body 130 rotates, and enable the pushing member 122 to move in a radial direction of a circumferential plane perpendicular to the rotation axis S. In other embodiments, the fixing cover 140 can also be a component fixed on the seat body 130, which is not limited in this application. Referring to FIGS. 10 to 14, the pushing member 122 is movably disposed on the fixing cover 140 of the seat assembly 100, and can extend out of the fixing cover 140 to be engaged with the limiting member 121. The fixing cover 140 is provided with a sliding groove 143. Both ends of the sliding groove 143 are open ends 1431, so that the pushing member 122 can at least partially extend through the corresponding open ends 1431 and extend out of the sliding groove 143. For example, the sliding groove 143 may be formed by two ribs 144 disposed on the fixing cover 140 and parallel to each other, but which is not limited thereto in this application. The pushing member 122 is disposed in the sliding groove 143 and slidable along the sliding groove 143. An extending direction of the sliding groove 143 is considered as a first direction D1, a moving direction of the pushing member 122 is parallel to the first direction D1. In an embodiment, the sliding groove 143 is located in the radial direction of the circumferential plane perpendicular to the rotation axis S. That is, the plane in which the pushing member 122 moves is perpendicular to the rotation axis S of the seat assembly 100, and the pushing member 122 or the extension line of the pushing member 122 extends through the rotation axis S.

In an embodiment, one end of the pushing member 122 is an engaging end 1221. The engaging end 1221 can extend through the corresponding open end 1431 and extend out of the sliding groove 143 to be engaged with the limiting member 121. Referring to FIG. 15, the fixing cover 140 is provided with limiting protrusions 145, the pushing member 122 is provided with stroke grooves 1224. The limiting protrusions 145 can be inserted into the stroke grooves 1224 to limit the moving stroke of the pushing member 122. The pushing member 122 is connected to the fixing cover 140 through fasteners 124 to prevent the pushing member 122 from being separated from the fixing cover 140. Specifically, the fasteners 124 are, for example, screws. The fasteners 124 at least partially extend through the stroke groove 1224 and are threadedly connected to the limiting protrusions 145, thereby connecting the pushing member 122 to the fixing cover 140 and enabling the pushing member 12 to be movable relative to the fixing cover 140. In other embodiments, the fixing cover 140 may be provided with the stroke groove 143, and the pushing member 122 may be provided with the limiting protrusion 145.

In some embodiments, as shown in FIGS. 10 to 14, the elastic reset member 123 is adapted to provide an elastic restoring force for the pushing member 122 so that the pushing member 122 always moves towards the limiting member 121. The elastic reset member 123 is, for example, a compression spring, but which is not limited thereto in the present application. The elastic reset member 123 is at least partially received in the sliding groove 143. With an end of the pushing member 122 away from the engaging end 1221 as a connecting end 1222, the elastic reset member 123 abuts against the connecting end 1222 of the pushing member 122 so that the engaging end 1221 of the pushing member 122 can extend out of the opening end 1431 of the sliding groove 143 and abut against the limiting member 121. In the present embodiment, two pushing members 122 are provided. The two pushing members 122 are symmetrically arranged on the fixing cover 140 of the seat assembly 100, but which is not limited thereto in the present application. For example, in other unillustrated embodiments, for example, one or more than two pushing members 122 may be provided. Referring to FIGS. 10 to 14, one elastic reset member 123 is provided. Two ends of the elastic reset member 123 respectively abut against the two pushing members 122, so that the two pushing members 122 move in opposite directions at the same time and respectively abut against the limiting member 121. The connecting end 1222 of each pushing member 122 is provided with a connecting protrusion 1223. One end of the elastic reset member 123 is sleeved on the connecting protrusion 1223 of one of the pushing members 122, and another end of the elastic reset member 123 is sleeved on the connecting protrusion 1223 of another of pushing members 122, so as to avoid the elastic reset member 123 from deflecting during the compressed process (i.e., during the energy storage process of the elastic reset member 123). In other unillustrated embodiments, more than one elastic reset member 123 may be provided. One end of each elastic reset member 123 abuts against the corresponding connecting end 1222 of the pushing member 122, and another end of each elastic reset member 123 is connected to a convex portion (not shown) on the fixing cover 140. The number of pushing members 122 and configurations thereof, and the number of elastic reset members 123 and configurations thereof, are not limited thereto in the present application. In some other unillustrated embodiments, the elastic reset member 123 may not be provided. For example, the pushing member 122 and the limiting member 121 may cooperate with each other by magnetic attraction, so that when the pushing member 122 rotates to be in a specified angle range, the pushing member 122 can be automatically rotated to a predetermined direction.

In some embodiments, as shown in FIGS. 10 to 14, the limiting member 121 is in a closed annular structure. The limiting member 121 is disposed on the upper base cover 210. Specifically, referring to FIG. 17, the limiting member is located on a surface of the upper base cover 210 facing the lower base cover 220. A projection of the insertion hole 211 (or the fixing cover 140) onto the plane perpendicular to the rotation axis S is located within an outer contour of a projection of the limiting member 121 onto the plane perpendicular to the rotation axis S. In other words, the projection of the limiting member 121 onto the plane perpendicular to the rotation axis S surrounds the projection of the insertion hole 211 (or the fixing cover 140) onto the plane perpendicular to the rotation axis S. It should be noted that the annular structure in this embodiment should be understood in a broad sense, and it does not only refer to a circular ring, but should be understood as any closed structure connected end to end, such as a rectangular ring, a polygonal ring, etc. In this embodiment, the limiting member 121 is roughly shaped as a rectangular ring. The pushing member 122 is adapted to be received in the limiting member 121 to abut against the limiting member 121.

In an embodiment, as shown in FIGS. 10 to 14, the limiting member 121 is provided with a limiting recess 1211 and a guide surface 1212. The limiting recess 1211 defines the predetermined direction. When the pushing member 122 is located in the predetermined direction, the engaging end 1221 of the pushing member 122 can be engaged with the limiting recess 1211, so that the pushing member 122 is limited in the predetermined direction. The limiting recess 1211 has an arc-shaped surface 12111 that protrudes in a direction away from the rotation axis S. The engaging end 1221 of the pushing member 122 is provided with an arc segment that matches the limiting recess 1211, so that the engaging end 1221 can be engaged with the limiting recess 1211, or be withdrawn from the limiting recess 1211 under the action of external force.

In this embodiment, the limiting member 121 has a rotationally symmetric structure and an axially symmetric structure. The limiting member 121 includes at least two limiting recesses 1211. The number of the limiting recesses 1211 is an integral multiple of the number of the pushing members 122. As shown in FIGS. 10 to 14, two pushing members 122 are provided, and four limiting recesses 1211 are provided. The four limiting recesses 1211 are symmetrically distributed about the rotation axis S, but which is not limited thereto in this application. An angle between two adjacent limiting recesses 1211 is approximately 90°. The four limiting recesses 1211 respectively correspond to the forward-facing use mode, the leftward-facing use mode, the rearward-facing use mode and the rightward-facing use mode of the child carrier 1. A rotation angle between any two of the use modes is approximately 90°. In other unillustrated embodiments, for example, one, two, three, or more than four limiting recesses 1211 may be provided. Through the cooperation between the limiting recesses 1211 and the pushing member 122, the limiting member 121 can at least limit the pushing member 122 in the forward-facing use mode or the rearward-facing use mode. The number of limiting recesses 1211 and pushing members 122 can be adjusted by those skilled in the art according to actual usage requirements.

As shown in FIGS. 10 to 14, at least one side of the limiting recess 1211 is provided with the guide surface 1212. The guide surface 1212 may be an inclined surface or an arc-shaped surface, and smoothly transition to the limiting recess 1211. The guide surface 1212 can define the specified angle range of the seat assembly 100. Specifically, the specified angle range refers to the rotatable angle range of the pushing member 122 when the seat assembly 100 is rotated such that the pushing member 122 abuts against the guide surface 1212 of the limiting member 121. The engaging end 1221 of the pushing member 122 is provided with a pushing surface 1225 adapted to cooperate with the guide surface 1212. The pushing surface 1225 is disposed on at least one side of the arc segment. In this embodiment, the pushing surfaces 1225 are respectively disposed on two sides of the arc segment. Referring to FIGS. 11 and 13, when the seat assembly 100 is rotated such that the pushing surface 1225 is at least partially in contact with the guide surface 1212, the pushing member 122 rotates towards a position in a predetermined direction and is engaged with the limiting recess 1211 through the cooperation between the pushing surface 1225 and the guide surface 1212 under the elastic restoring force of the elastic reset member 123 (see FIGS. 12 and 14). A distance between any point on the arc-shaped surface 12111 of the limiting recess 1211 and the rotation axis S is greater than or equal to a distance between any point on the guide surface 1212 and the rotation axis S. A distance between the point (i.e., the valley) on the arc-shaped surface 12111 of the limiting recess 1211 that is farthest from the rotation axis S and the rotation axis S is greater than the distance between any point on the guide surface 1212 and the rotation axis S. In this way, when the pushing member 122 changes from the position where it abuts against the guide surface 1212 to the position where it is engaged with the limiting recess 1211, the elastic reset member 123 at least partially releases the stored elastic potential energy, so that the elastic potential energy released by the elastic reset member 123 can be used to push the pushing member to move towards the limiting recess 1211. Specifically, referring to FIGS. 11 and 13, when the engaging end 1221 of the pushing member 122 begins to abut against the guide surface 1212 (that is, when the pushing member 122 contacts a starting side 12121 of the guide surface 1212), the elastic reset member 123 is compressed, so that the elastic reset member 123 is in an elastic energy storage state. The elastic reset member 123 can generate an elastic restoring force in the first direction D1, on the pushing member 122, so that the guide surface 1212 can apply a pushing force F in the direction perpendicular to the guide surface 1212, to the pushing member 122. The pushing force F can be decomposed into a first force component F1 parallel to the first direction D1 and a second force component F2 parallel to a second direction D2. The first direction D1 and the second direction D2 are perpendicular to each other. The first force component F1 can interact with the elastic restoring force to enable the pushing member 122 to move in the first direction D1, and the second force component F2 can enable the pushing member 122 to automatically rotate towards a position in a predetermined direction. During the rotation of the pushing member 122 towards a position in the predetermined direction, the elastic potential energy stored in the elastic reset member 123 is slowly released, and the engaging end 1221 of the pushing member 122 moves along the guide surface 1212 towards a position to be engaged with the limiting recess 1211. When the engaging end 1221 of the pushing member 122 is engaged with the limiting recess 1211, the pushing member 122 is limited in the predetermined direction.

In some embodiments, as shown in FIGS. 10 to 14, the limiting member 121 further includes a driving surface 1213. The driving surface 1213 and the guide surface 1212 are respectively disposed on two sides of the limiting recess 1211, so that the pushing member 122 can move along the driving surface 1213 to withdraw from the limiting recess 1211. The driving surface 1213 can be an inclined surface or an arc-shaped surface, and transition smoothly to the limiting recess 1211. The driving surface 1213 and the guide surface 1212 are symmetrically arranged on the two sides of the limiting recess 1211, that is, two ends of the arc-shaped surface 12111 of the limiting recess 1211 are connected to the driving surface 1213 and the guide surface 1212 respectively. In this embodiment, the driving surface 1213 and the guide surface 1212 have exactly the same configuration (that is, it can be considered that guide surfaces 1212 are disposed on the two sides of the limiting recess 1211, or that driving surfaces 1213 are disposed on both sides of the limiting recess 1211), but which is not limited thereto in this application. With such configurations, the seat assembly 100 can automatically rotate in a clockwise direction relative to the base 200 and automatically rotate in a counterclockwise direction relative to the base 200 when the seat assembly 100 is located within the specified angle range.

In an embodiment, as shown in FIGS. 10 to 14, the limiting member 121 is further provided with a slope surface 1214. The slope surface 1214 is connected to the side of the guide surface 1212 away from the limiting recess 1211, that is, the slope surface 1214 is connected to the starting side 12121 of the guide surface 1212. The slope surface 1214 smoothly transitions to the guide surface 1212. The slope surface 1214 is, for example, an arc-shaped surface convex away from the rotation axis S. A distance between any point on the slope surface 1214 and the rotation axis S is less than a distance between the point on the arc-shaped surface 12111 of the limiting recess 1211 that is farthest from the rotation axis S (that is, the valley of the limiting recess 1211) and the rotation axis S. The engaging end 1221 of the pushing member 122 can abut against the slope surface 1214 and compress the elastic reset member 123, so that the elastic reset member 123 is in the elastic energy storage state. In this embodiment, two slope surfaces 1214 are provided. The two slope surfaces 1214 are symmetrically distributed on two sides of the limiting recess 1211, but which is not limited thereto in the present application.

In some embodiments, as shown in FIGS. 10 to 14, the limiting member 121 is further provided with a lifting surface 1215 that allows the slope surface 1214 to smoothly transition to the guide surface 1212. Two sides of the lifting surface 1215 are respectively connected to the slope surface 1214 and the guide surface 1212. By providing the lifting surface 1215 between the slope surface 1214 and the guide surface 1212, the inclination angle of the guide surface 1212 can be increased, and the second force component F2 parallel to the second direction L2, generated by the guide surface 1212 can be increased, so that the seat assembly 100 can be more easily automatically rotated relative to the base 200.

With the above-mentioned structural configuration, referring to FIGS. 3, 4 and 10, when the seat assembly 100 of the child carrier 1 is in the forward-facing use mode, the pushing member 122 is in the first predetermined direction Dp1, and the engaging member 111 of the rotatable engaging mechanism 110 is engaged with the forward positioning hole 2011. A caregiver can operate the unlocking operation member 116 of the rotatable engaging mechanism 110 to make the engaging member 111 withdraw from the forward positioning hole 2011 (refer to FIG. 5), and the caregiver can apply external force to the seat assembly 100 (or the pushing member 122) to cause the pushing member 122 to rotate in the clockwise direction and withdraw from the limiting recess 1211 along the pushing surface 1213. Referring to FIG. 11, when the seat assembly 100 (or the pushing member 122) rotates in the clockwise direction under the action of an external force until the pushing member 122 is located within the specified angle range (i.e., the pushing surface 1225 of the pushing member 122 abuts against the guide surface 1212), under the action of the elastic restoring force of the elastic reset member 123, the pushing member 122 abuts against the guide surface 1212, so that the guide surface 1212 generates the pushing force F perpendicular to the guide surface 1212 on the pushing member 122. The pushing force F can be decomposed into the first force component F1 in the first direction D1 and the second force component F2 perpendicular to the first direction D1. The first force component F1 can interact with the elastic restoring force, to enable the pushing member 122 to move in the first direction D1 relative to the fixing cover 140, and the second force component F2 can enable the pushing member 122 to rotate towards the position in the predetermined direction Dp2, so that the pushing member 122 can automatically move along the guide surface 1212 towards the limiting recess 1211. Referring to FIG. 12, when the engaging end 1221 of the pushing member 122 is engaged with the limiting recess 1211, the pushing member 122 is in the second predetermined direction Dp2, and the seat assembly 100 is in the leftward-facing use mode. In this case, the pushing member 122 is limited in the second predetermined direction by the limiting member 121, that is, the seat assembly 100 is limited to be in the rightward-facing use mode.

During the process of adjusting the seat assembly 100 from the forward-facing use mode to the leftward-facing use mode, when the seat assembly 100 is rotated so that the pushing member 122 is within a specified angle range, the pushing member 122 of the rotation angle adjustment mechanism 120 can cooperate with the limiting member 121, which can further automatically rotate the pushing member 122 to a predetermined direction, thereby adjusting the seat assembly 100 from the forward-facing use mode to the leftward-facing use mode. During such process, there is no need to accurately rotate the seat assembly 100 such that the pushing member 122 is located in the predetermined direction, which improves the operational experience of adjusting the use mode of the seat assembly.

When it is required to further adjust the seat assembly 100 from the leftward-facing use mode to the rearward-facing use mode, the caregiver can apply an external force to the seat assembly 100 (or the pushing member 122) to cause the pushing member 122 to rotate in the clockwise direction and withdraw from the limiting recess 1211 along the pushing surface 1213. Referring to FIG. 13, when the seat assembly 100 (or the pushing member 122) rotates in the clockwise direction under the action of external force until the pushing member 122 is located within the specified angle range (that is, when the pushing surface 1225 of the pushing member 122 abuts against the guide surface 1212), under the elastic restoring force of the elastic reset member 123, the pushing member 122 pushes against the guide surface 1212, so that the guide surface 1212 exerts the pushing force F on the pushing member 122 in the direction perpendicular to the guide surface 1212. The pushing force F can be decomposed into the first force component F1 in the first direction D1 and the second force component F2 perpendicular to the first direction D1. The first force component F1 can interact with the elastic restoring force, so that the pushing member 122 can move in the first direction D1 relative to the fixing cover 140, and the second force component F2 can enable the pushing member 122 to rotate towards a position in the predetermined direction Dp3. Referring to FIG. 14, when the pushing member 122 can automatically move along the guide surface 1212 to the limiting recess 1211, the pushing member 122 is in the third predetermined direction Dp3, and the seat assembly 100 is in the rearward-facing use mode. In this case, the pushing member 122 is limited in the third predetermined direction by the limiting member 121, that is, the seat assembly 100 is limited in the rearward-facing use mode.

The rotation angle adjustment mechanism according to the present application and the child carrier including the same can automatically adjust the rotation angle of the seat assembly, thereby avoiding insufficient rotation angle or excessive rotation angle of the seat assembly. In other words, according to the child carrier and the rotation angle adjustment mechanism of the embodiments of the present application, in the process of adjusting the use mode of the seat assembly, it only needs to rotate the seat assembly until the pushing member is within the specified angle range, and then through the cooperation between the limiting member and the pushing member, the pushing member is further automatically rotated to a predetermined direction, thereby adjusting the seat assembly to be in the desired use mode. During such process, there is no need to accurately rotate the seat assembly such that the pushing member is in the predetermined direction, which avoids the problem of insufficient rotation angle and excessive rotation angle of the seat assembly, and improves the operational experience of adjusting the use mode of the seat assembly.

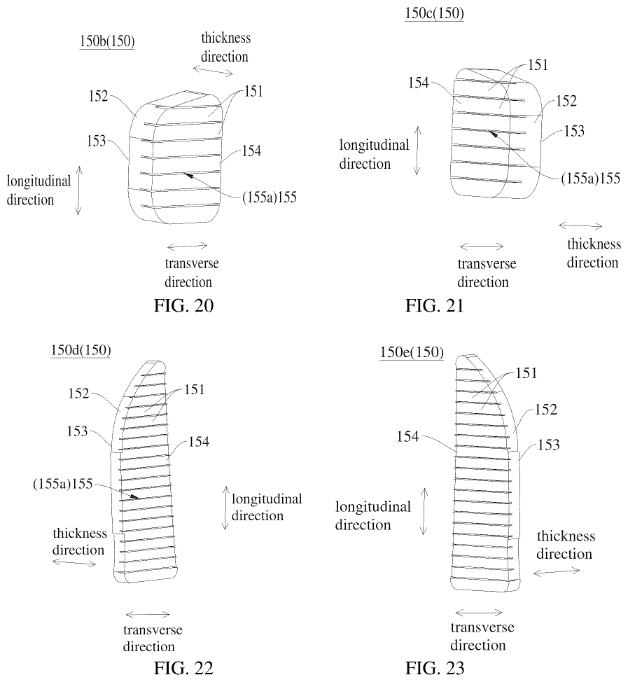

FIGS. 18 to 23 are schematic views of a buffer body 150 of the child carrier. In some embodiments, as shown in FIG. 18, the seat assembly 100 further includes a buffer body 150 disposed on the seat body 130 to enhance the protection effect for children. The buffer body 150 is made of foam, for example. The buffer body 150 includes a headrest rear buffer body 150a, a headrest right buffer body 150b, a headrest left buffer body 150c, a right wing buffer body 150d, and a left wing buffer body 150e. The seat body 130 includes a headrest part 131 and side parts 132 located on both sides of the headrest part 131. The headrest rear buffer body 150a, the headrest right buffer body 150b and the headrest left buffer body 150c are disposed on the headrest part 131. The headrest right buffer body 150b and the headrest left buffer body 150c are symmetrically disposed on both sides of the headrest rear buffer body 150a, so that the head of the child siting in the child carrier 1 can be well cushioned. The right wing buffer body 150d and the left wing buffer body 150e are respectively disposed on the two side parts 132 of the seat body 130. The shapes of the headrest rear buffer body 150a, the headrest right buffer body 150b, the headrest left buffer body 150c, the right wing buffer body 150d and the left wing buffer body 150e can be set according to the shapes of the headrest part 131 and the side parts 132. In this embodiment, the longitudinal section of the headrest rear buffer body 150a is generally rectangular; the longitudinal section of the headrest left buffer body 150 and the longitudinal section of the headrest right buffer body 150b are generally trapezoidal; and the longitudinal section of the left wing buffer body and the longitudinal section of the right wing buffer body 150d are generally right-angled trapezoids, but which are not limited thereto in the present application.

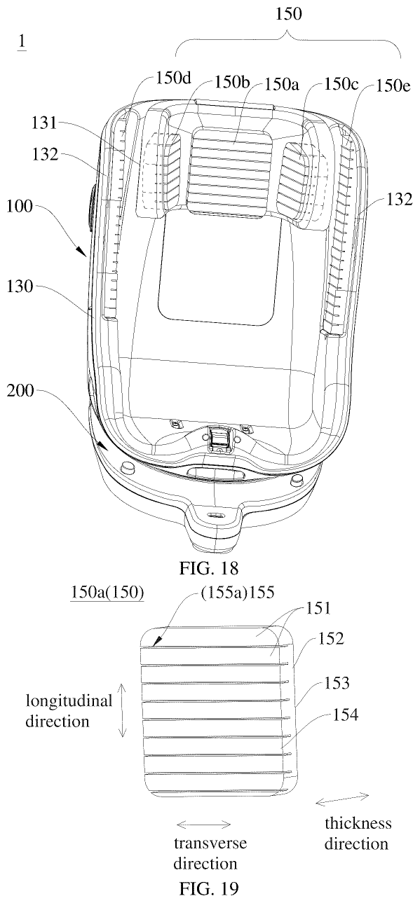

As shown in FIGS. 19 to 23, a surface of the buffer body 150 (e.g., the headrest rear buffer body 150a, the headrest right buffer body 150b, the right wing buffer body 150d, or the left wing buffer body 150e) configured to be connected to the seat body 130 is taken as a back surface 153, and a surface of the buffer body 150 opposite to the back surface 153 is taken as a front surface 154. The buffer body 150 is provided with a plurality of buffer blocks 151 that are spaced apart. A buffer gap 155 is formed between adjacent buffer blocks 151. The buffer gap 155 can be formed by CNC computer machine or die cutting. With the above-mentioned structural configuration, the buffer body 150 is easier to deform, thereby improving the buffering performance of the buffer body 150. In some embodiments, as shown in FIGS. 19 to 23, the buffer gap 155 includes a plurality of transverse gaps 155a that extend in the transverse direction and are parallel to each other, but which is not limited thereto in the present application. For example, in other embodiments, the buffer gap 155 includes a plurality of longitudinal gaps that extend in the longitudinal direction and are parallel to each other. In some further embodiments, the buffer gap 155 includes a plurality of transverse gaps 155a that extend in the transverse direction and are parallel to each other, and a plurality of longitudinal gaps that extend in the longitudinal direction and are parallel to each other. In some other embodiments, the buffer gap 155 may include: a first inclined gap extending in a first inclined direction at an angle to both the transverse direction and the longitudinal direction; and a second inclined gap extending in a second inclined direction at an angle to both the transverse direction and the longitudinal direction. The first inclined direction intersects with the second inclined direction. The buffer gap 155 can extend in any direction as desired, and which is not limited in this application. In an embodiment, referring to FIGS. 19 to 23, the buffer body 150 further includes a connecting part 152. The plurality of buffer blocks 151 are connected together by the connecting part 152. The buffer body 150 is integrally formed. A plurality of buffer gaps 155 (for example, transverse gaps 155a) extend through the buffer body 150 (for example, in the transverse direction). For example, the plurality of transverse gaps 155a extend through two sides of the buffer body 150 in the transverse direction. The plurality of buffer gaps 155 extend into but does not extend through the buffer body 150 in the thickness direction, that is, the plurality of buffer gaps 155 extend from the front surface 154 of the buffer body 150 into the inside of the buffer body 150 but do not reach the back surface 153 of the buffer body 150. The portion of the buffer body 150 not extended through by the buffer gaps 155 may form the connection portion 152, for example, the connection portion 152 is formed near the back surface 153 of the buffer body 150). With such configuration, the front surface 153 of the buffer body 150 is easy to deform to improve the buffering performance of the buffer body 150, and the buffer body 150 are formed as a whole, so as to facilitate the buffer body 150 to be arranged on the seat body 130.

In other unillustrated embodiments, the plurality of buffer gaps 155 may not extend through the buffer body 150 in their extending directions (e.g., the transverse direction, the longitudinal direction, the first inclined direction, the second inclined direction, etc.). For example, the lateral gaps 155a do not extend through the buffer body 150 in the transverse direction. The portions of the buffer body 150 not extended through by the buffer gaps 155 in the transverse direction (for example, portions near the left and right sides, near the left side, or near the right side in the transverse direction) form the connecting part 152. The plurality of buffer gaps 155 all extend through the buffer body 150 in the thickness direction. Alternatively, the plurality of buffer gaps 155 partially extend through the buffer body 150 in the thickness direction. For example, the transverse gaps 155a of the buffer body 150 extend through the buffer body 150 in the thickness direction, but the longitudinal gaps of the buffer body 150 does not extend through the buffer body 150 in the thickness direction. Alternatively, the transverse gaps 155a of the buffer body 150 do not extend through the buffer body 150 in the thickness direction, but the longitudinal gaps of the buffer body 150 extend through the buffer body 150 in the thickness direction. etc.). Alternatively, none of the plurality of buffer gaps 155 extends through the buffer body 150 in the thickness direction. The buffer gaps 155 may be arranged to or not to extend through the buffer body 150 in the thickness direction, and which is not limited in this application. In some other unillustrated embodiments, the buffer body 150 may not be provided with the connecting part 152, and the plurality of buffer blocks 151 may be separated from each other, that is, the buffer gaps 155 may extend through the buffer body 150 in both their extending direction and the thickness direction.

With the buffer body 150 configured as above, the buffer body 150 can be deformed more easily, thereby improving the buffering performance of the buffer body 150, thereby better protecting children sitting in the child carrier.

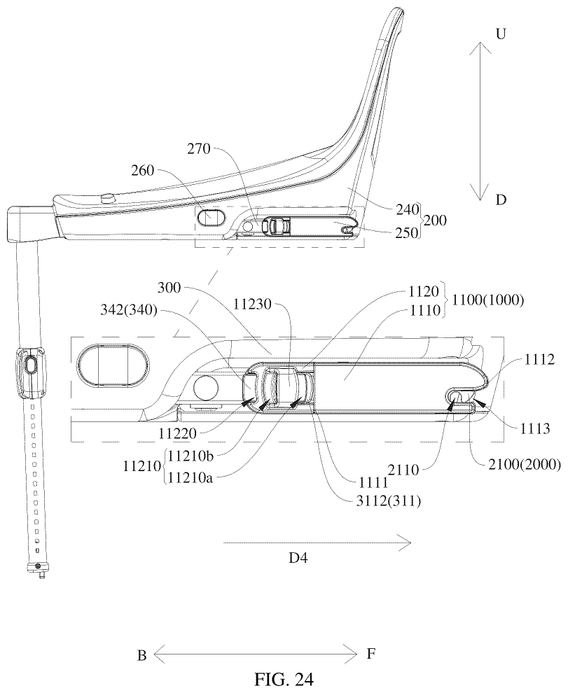

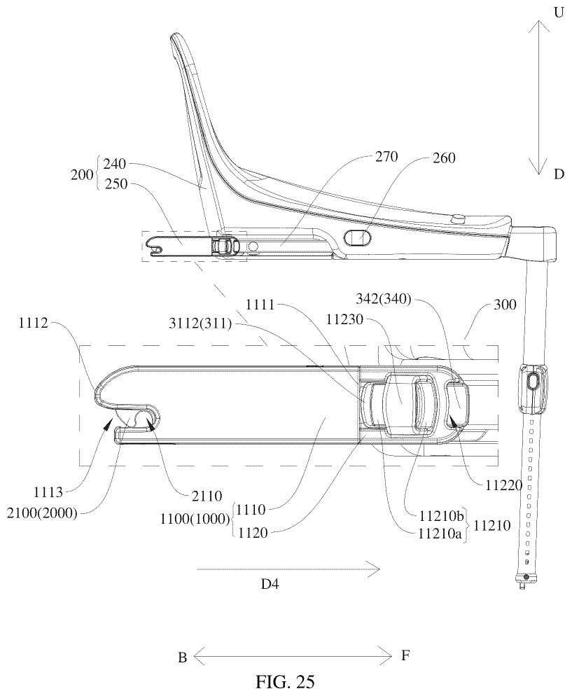

According to another embodiment of the present application, the base 200 of the child carrier 1 includes a base body 240 and a fixing device 250, as shown in FIGS. 1, 24 and 25. A telescopic unlocking button 260 and a telescopic rod 270 are disposed on the base body 240. A first end of the telescopic rod 270 is fixed to the base body 240, and a second end of the telescopic rod 270 can be switched between an extended state (as shown in FIG. 25) and a retracted state (as shown in FIG. 24) relative to the base body 240. The telescopic unlocking button 260 is operable to unlock the telescopic rod 270 and allow the telescopic rod 270 to switch between the extended state and the retracted state. The fixing device 250 is connected to the second end of the telescopic rod 270, so that the fixing device 250 can extend out of or retract into the base body 240. In this embodiment, two fixing devices 250 and two telescopic rods 270 are provided, and are respectively arranged on both sides of the base body 240. Hereinafter, one of the fixing devices 250 is taken as an example to specifically describe its configuration.

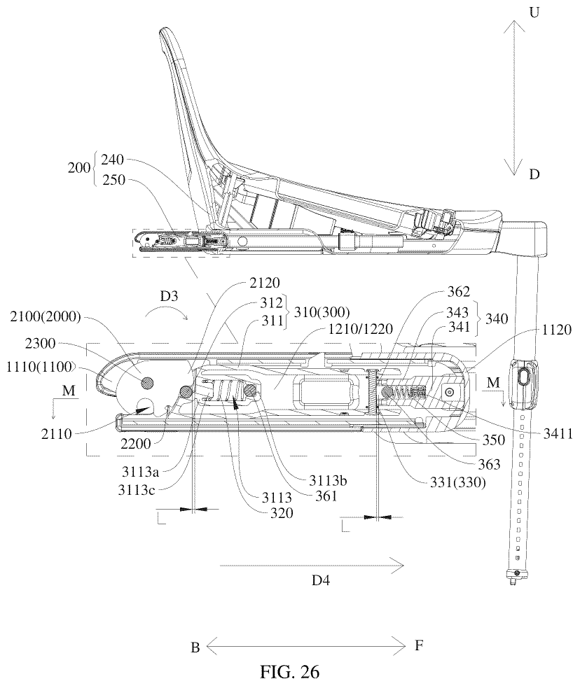

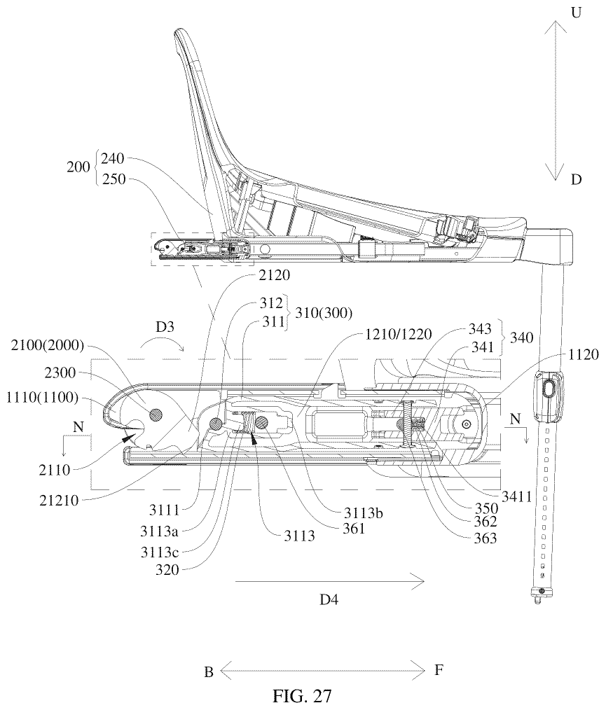

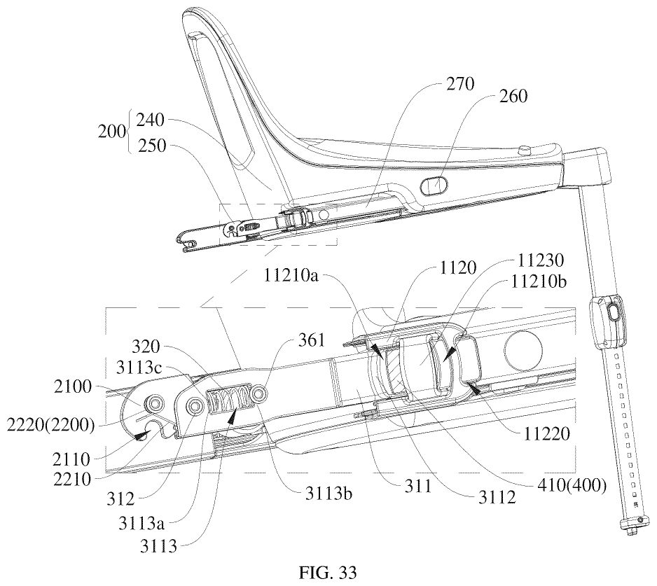

As shown in FIGS. 24 and 25, the fixing device 250 includes a connecting assembly 1000, an engagement mechanism 2000, and a locking mechanism 300. The connecting assembly 1000 is connected to the base body 240 through the telescopic rod 270. As shown in FIGS. 26 and 27, the engagement mechanism 2000 includes an engaging element 2100 and a first reset member 2200 (as shown in FIG. 33). The engaging element 2100 is pivotally connected to the connecting assembly 1000. The engaging element 2100 is rotatable between an opened position (as shown in FIG. 27) and a closed position (as shown in FIG. 26). When the engaging element 2100 is in the closed position, the engaging element 2100 can be engaged with an engaging rod on the vehicle seat. When the engaging element 2100 is in the opened position, the engaging element 2100 can be disengaged from the engaging rod on the vehicle seat. The first reset member 2200 is disposed between the engaging element 2100 and the connecting assembly 1000. The first reset member 2200 is adapted to bias the engaging element 2100 to rotate toward the opened position. The locking mechanism 300 is disposed on the connecting assembly 1000. The locking mechanism 300 is switchable between a locked state and an unlocked state. When the locking mechanism 300 is in the locked state, the engaging element 2100 is locked in the closed position, and when the locking mechanism 300 is in the unlocked state, the engaging element 2100 is locked in the closed position. In this way, when the locking mechanism 300 is in the unlocked state, the engaging element 2100 will be automatically switched to the opened position under the action of the first reset member 2200, so that the unlocking can be performed conveniently and smoothly, and the error locking of the engaging element 2100 will not easily occur. The fixing device 250 of this embodiment has a simple configuration, is easy to manufacture, has low cost and is convenient to operate.

Specifically, as shown in FIGS. 24 to 27, the connecting assembly 1000 includes a connecting housing 1100 and a reinforcing member 1200.

Further, as shown in FIGS. 24 and 25, the connecting housing 1100 has a substantially rectangular structure. The connecting housing 1100 includes a first housing 1110 and a second housing 1120 that are connected to each other. The first housing 1110 has a first side 1111 and a second side 1112 in its length direction. The second side 1112 of the first housing 1110 is provided with an inwardly recessed first groove 1113.

As shown in FIGS. 24 and 25, the second housing 1120 is located on the first side 1111 of the first housing 1110. The second housing 1120 is connected to the base body 240 through the telescopic rod 270. The second housing 1120 also has a generally rectangular structure. In this embodiment, the width of the second housing 1120 is substantially the same as the width of the first housing 1110, and the length of the second housing 1120 is less than the length of the first housing 1110. In other embodiments, the sizes of the first housing 1110 and the second housing 1120 can also be appropriately adjusted as needed. The second housing 1120 is provided with a display window 11210 that can be used to display an indication identifier (detailed below) of an indication assembly 400. In this embodiment, the second housing 1120 is provided with two display windows 11210, including a first display window 11210a and a second display window 11210b. The two display windows 11210 are spaced apart in the length direction of the second housing 1120. An operating port 11220 is disposed on the side of the second housing 1120 away from the first housing 1110. At least a portion of the locking mechanism 300 can extend out of the operating port 11220 in order to be operated.

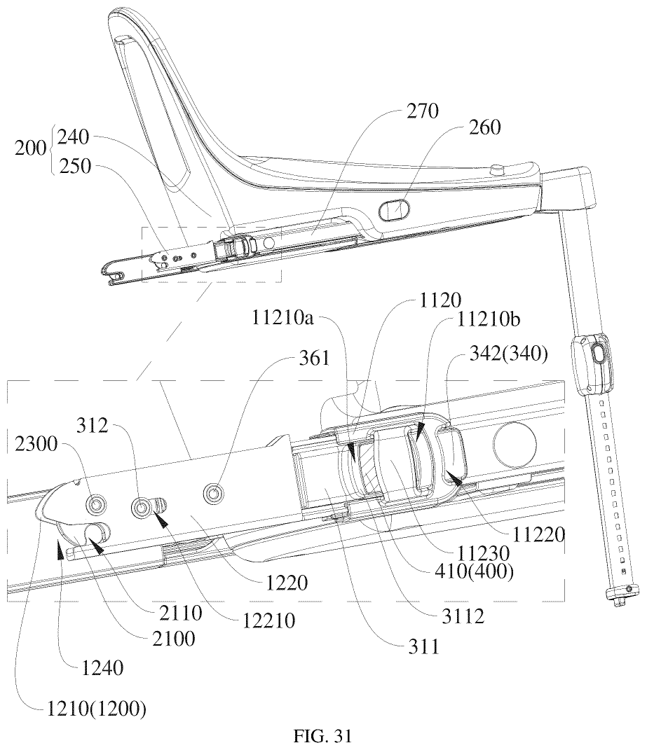

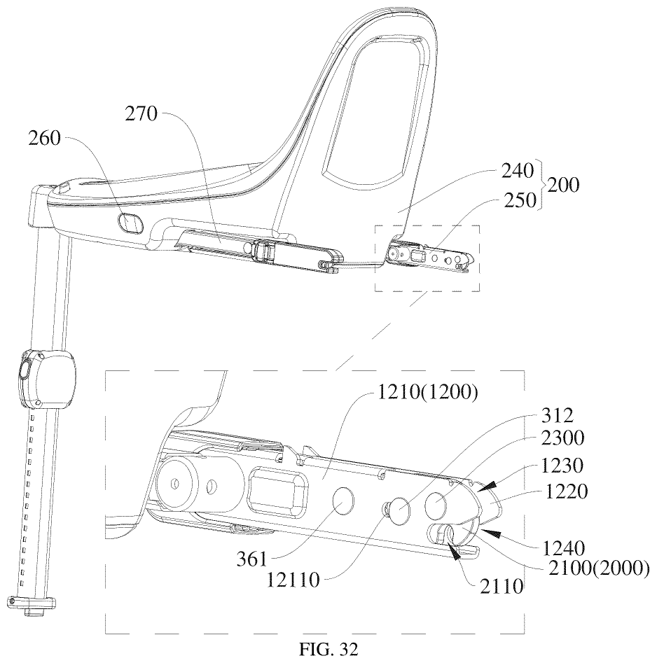

Further, as shown in FIGS. 26 to 29, the reinforcing member 1200 includes a first reinforcing plate 1210 and a second reinforcing plate 1220 that are oppositely arranged and have a substantially rectangular plate-like structure. The first reinforcing plate 1210 and the second reinforcing plate 1220 are spaced apart to form a mounting cavity 1230. One side of the first reinforcing plate 1210 and one side of the second reinforcing plate 1220 are also recessed inward to form second grooves 1240 (as shown in FIGS. 31 and 32) respectively. The connecting housing 1100 covers the first reinforcing plate 1210 and the second reinforcing plate 1220. The first reinforcing plate 1210 is located on a side of the second reinforcing plate 1220 facing away from the display window 11210. More specifically, the shape of the first reinforcing plate 1210 substantially matches the shape of the connecting housing 1100, that is, matches the shape formed by connecting the first housing 1110 to the second housing 1120. The shape of the second reinforcing plate 1220 matches the shape of the first housing 1110, that is, the second reinforcing plate 1220 is shorter than the first reinforcing plate 1210 in length. This facilitates a driving member 311 of the locking mechanism 300 (see details below) to extend out of the mounting cavity 1230.

As shown in FIGS. 30 to 32, two second grooves 1240 face and are in communication with the first groove 1113, to form an engaging opening 125. The engaging opening 125 can allows at least a portion of the engaging element 2100 to be exposed so that the engaging element 2100 can be engaged with the engaging rod of the vehicle seat extending into the engaging opening 125. The reinforcing member 1200 can facilitate the arrangements of the engagement mechanism 2000 and the locking mechanism 300. The connecting housing 1100 covers the first reinforcing plate 1210 and the second reinforcing plate 1220, which can make the appearance of the fixing device 250 neater and avoid the user from being clamped by some parts of the engagement mechanism 2000 and the locking mechanism 300.

As described above, the engagement mechanism 2000 includes the engaging element 2100 and the first reset member 2200. As shown in FIGS. 32 to 34, the engaging element 2100 is disposed in the mounting cavity 1230, and specifically, is pivotally connected to an engaging hook of the reinforcing member 1200 through a pivot shaft 2300. The engaging element 2100 has a generally elliptical sheet structure. An engaging groove 2110 is provided at the edge of the engaging element 2100. When the engaging element 2100 is in the closed position, at least a portion of the engaging element 2100 having the engaging groove 2110 can be exposed at the engaging opening 125. The engaging rod of the vehicle seat can be engaged in the engaging groove 2110 to achieve the connection between the base 200 and the vehicle seat. As shown in FIGS. 26 and 27, a portion of the engaging element 2100 protrudes in a direction away from the pivot shaft 2300 to form a limiting part 2120. The rotation direction of the engaging element 2100 from the closed position to the opened position is taken as the third direction D3. The engaging element 2100 pivots relative to the reinforcing member 1200 (or pivots relative to the connecting assembly 1000) with the pivot shaft 2300 as the pivot center. The engaging groove 2110 is located in the third direction D3 of the limiting part 2120. That is, in this embodiment, as shown in FIGS. 26 and 27, the front and rear and up and down directions of the base body 240 are taken as the reference. That is, in FIGS. 26 and 27, the same direction as the fourth direction D4 is taken as the front direction (indicated by arrow “F”'), the direction opposite to the fourth direction D4 is taken as the backward direction (indicated by arrow “B”), and the upward direction (indicated by arrow “U”) and the downward direction (indicated by arrow “D”) are respectively perpendicular to the fourth direction D4. When the engaging element 2100 is in the closed position, the limiting part 2120 is located at the upper front of the pivot shaft 2300, and the engaging groove 2110 is located below or at the lower front of the pivot shaft 2300. When the engaging element 2100 is in the closed position, the limiting part 2120 is located at the lower front of the pivot shaft 2300, and the engaging groove 2110 is located at the lower rear of the pivot shaft 2300.

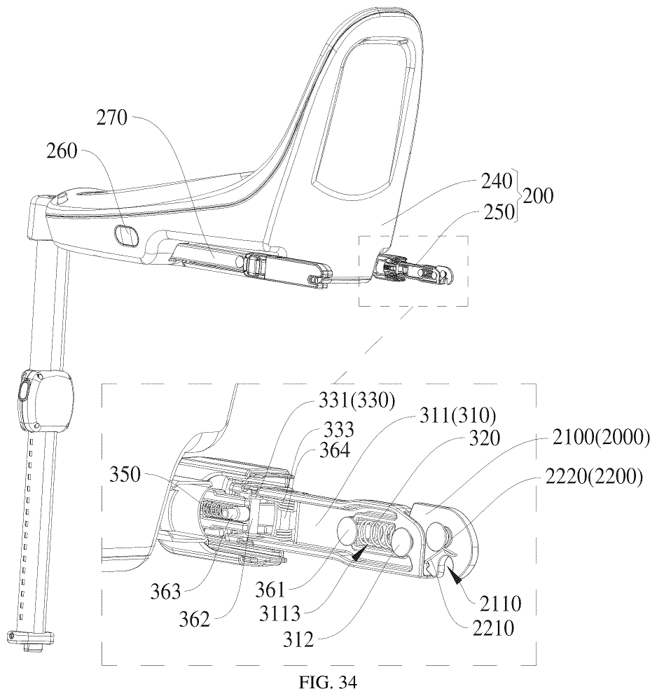

In this embodiment, as shown in FIGS. 33 and 34, the first reset member 2200 includes a torsion spring. The torsion spring includes two ends 2210 and a first collar 2220 located between the two ends 2210. The first collar 2220 is sleeved on the pivot shaft 2300. The two ends 2210 respectively abut against the engaging element 2100 and the reinforcing member 1200 (i.e., the first reinforcing plate 1210 or the second reinforcing plate 1220), so that the first reset member 2200 is adapted to bias the engaging element 2100 to rotate toward the opened position.

Specifically, as shown in FIGS. 26 to 29, the locking mechanism 300 includes a locking assembly 310, a second reset member 320, a third reset member 330, a safety unlocking member 340, and a fourth reset member 350.

Furthermore, the locking assembly 310 is movably disposed in the mounting cavity 1230 and is movable between a first locked position and a first unlocked position. When the locking assembly 310 is in the first locked position, the locking assembly 310 can cooperate with the limiting part 2120 of the engaging element 2100 to lock the engaging element 2100 in the closed position. When the locking assembly 310 is in the first unlocked position, the locking assembly 310 is separated from the limiting part 2120.

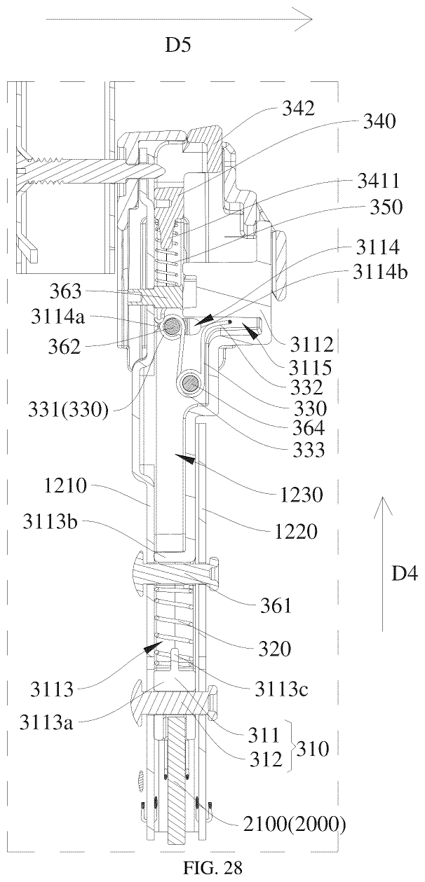

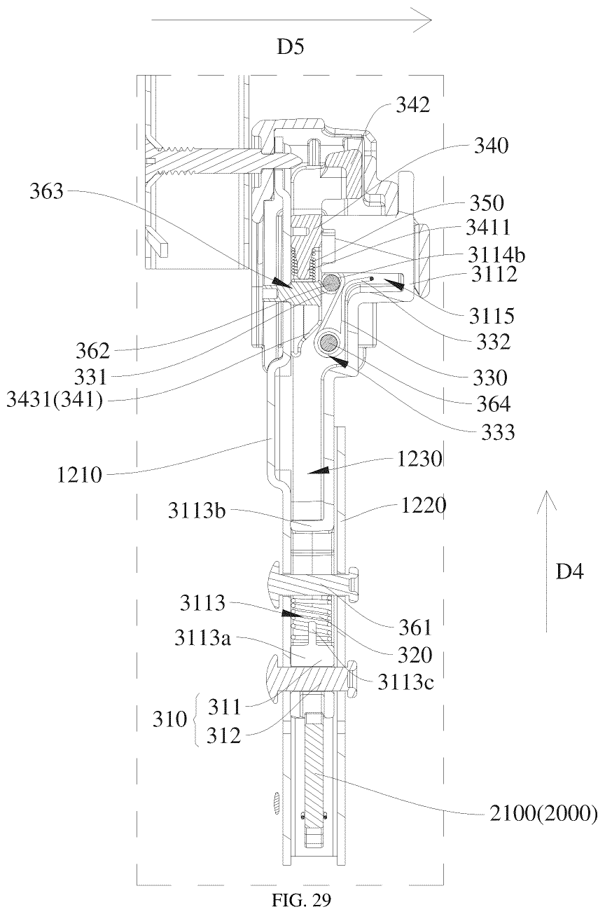

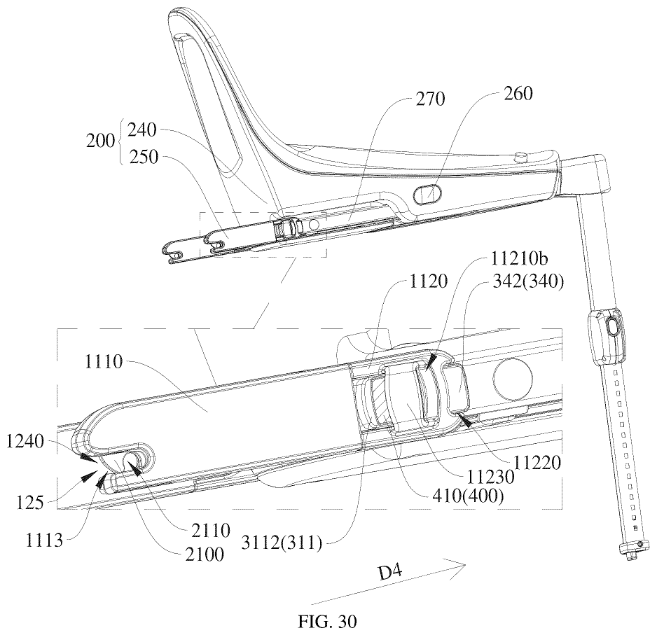

Specifically, as shown in FIGS. 26 and 27, the locking assembly 310 includes a driving member 311 and a limiting pin 312. The driving member 311 is operable to move from the first unlocked position to the first locked position. The driving member 311 has a generally a rectangular plate-shaped structure. A mounting groove 3113 is disposed on the side of the driving member 311 adjacent to the engaging element 2100. The side of the driving member 311 away from the engaging element 2100 protrudes towards the connecting housing 1100 (i.e., in a fifth direction D5 shown in FIGS. 28 and 29) to form a first operating part 3112. The first operating part 3112 can extend out of the mounting cavity 1230 through one of the display windows 11210 to be operated.

Further, as shown in FIGS. 26 to 29, the limiting pin 312 is fixed to the driving member 311. The limiting pin 312 can push against the limiting part 2120 to lock the engaging element 2100 in the closed position. Specifically, as shown in FIGS. 31 and 32, the first reinforcing plate 1210 is provided with a first elongated groove 12110, and the second reinforcing plate 1220 is provided with a second elongated groove 12210. The first elongated groove 12110 is arranged to face the second elongated groove 12210. The limiting pin 312 extends through the first elongated groove 12110, the driving member 311 and the second elongated groove 12210. In this way, the limiting pin 312 is fixed to the driving member 311 and can move along the first elongated groove 12110 and the second elongated groove 12210. In this embodiment, the first elongated groove 12110 and the second elongated groove 12210 are both disposed in the length direction of the connecting housing 1100, so that the driving member 311 can drive the limiting pin 312 to move between the first locked position and the first unlocked position.

In this embodiment, the first elongated groove 12110 and the second elongated groove 12210 have the same shape and completely overlap with each other. In other embodiments, the first elongated groove 12110 and the second elongated groove 12210 may also have different shapes and partially overlap with each other. The limiting pin 312 is limited to move along the overlapping portion between the first elongated groove 12110 and the second elongated groove 12210.

Further, the second reset member 320 is disposed between the connecting assembly 1000 and the locking assembly 310. The second reset member 320 is adapted to bias the locking assembly 310 to move towards the first locked position. Specifically, the second reset member 320 is adapted to bias the driving member 311 and the limiting pin 312 fixed to the driving member 311 to move towards the first locked position and to be locked in the first locked position. The driving member 311 has a first matching part 3111 (for example, an inclined surface) at one end adjacent to the engaging element 2100. The limiting part 2120 has a second matching part 21210 (for example, an inclined surface) matching the first matching part 3111. In the process of the driving member 311 moving towards the first locked position, the first matching part 3111 pushes against the second matching part 21210, and the driving member 311 drives the engaging element 2100 to rotate from the opened position to the closed position in the direction opposite to the third direction D3. The limiting pin 312 moves to the first locked position and abuts against the limiting part 2120 to lock the engaging element 2100 in the closed position. Specifically, as shown in FIGS. 26 and 27, the driving member 311 is provided with the mounting groove 3113 adjacent to the limiting pin 312. The second reset member 320 includes a spring and is received in the mounting groove 3113. The locking mechanism 300 may further include a positioning pin 361. The positioning pin 361 extends through the first reinforcing plate 1210, the mounting groove 3113 and the second reinforcing plate 1220 in sequence. The mounting groove 3113 has a first groove wall 3113a and a second groove wall 3113b facing the first groove wall 3113a. The first groove wall 3113a is closer to the limiting pin 312 than the second groove wall 3113b. The first groove wall 3113a has a first mounting protrusion 3113c. One end of the second reset member 320 is sleeved on the first mounting protrusion 3113c and abuts against the first groove wall 3113a, and another end of the second reset member 320 abuts against the positioning pin 361. In this way, the second reset member 320 can be prevented from deflecting during the biasing process. When the driving member 311 is in the first locked position, as shown in FIG. 26, the positioning pin 361 abuts against the second groove wall 3113b. When the driving member 311 moves from the first locked position to the first unlocked position, as shown in FIG. 27, the positioning pin 361 is located between the first groove wall 3113a and the second groove wall 3113b, and the second reset member 320 is compressed.

Further, the driving member 311 is provided with a first safety locking part, and the connecting assembly 1000 is provided with a second safety locking part. The first safety locking part and the second safety locking part can separably push against or be separably engaged with each other to prevent the driving member 311 from moving towards the first unlocked position. The third reset member 330 is disposed between the driving member 311 and the first safety locking part. The third reset member 330 is configured to provide an elastic force to engage the first safety locking part with the second safety locking part or push the first safety locking part against the second safety locking part. In this way, the first operating part 3112 of the driving member 311 can be prevented from being accidentally touched and accidentally unlocked.

Specifically, the first safety locking part includes a safety pin 362 slidably disposed on the driving member 311, and the second safety locking part includes a retaining pin 363 fixed on the connecting assembly 1000 and protruding toward the mounting cavity 1230 between the first reinforcing plate 1210 and the second reinforcing plate 1220. As shown in FIGS. 28 and 29, the safety pin 362 can be installed by providing a sliding hole 3114 on the driving member 311, and inserting the safety pin 362 into the sliding hole 3114. The safety pin 362 is slidable in the sliding hole 3114. The sliding hole 3114 has a first end 3114a and a second end 3114b in the direction from the first reinforcing plate 1210 to the second reinforcing plate 1220 (i.e., in the fifth direction D5 shown in FIGS. 28 and 29). When the safety pin 362 slides to the first end 3114a, the safety pin 362 pushes against the side of the retaining pin 363 facing the engaging element 2100. When the safety pin 362 slides to the second end 3114b, the safety pin 362 is separated from the retaining pin 363. Specifically, the retaining pin 363 is fixed on the first reinforcing plate 1210. Specifically, the sliding hole 3114 includes a strip hole extending in the direction from the first reinforcing plate 1210 to the second reinforcing plate 1220 (that is, in the fifth direction D5 shown in FIGS. 28 and 29), that is, the length direction of the strip hole is perpendicular to both the first reinforcing plate 1210 and the second reinforcing plate 1220.

In this embodiment, as shown in FIGS. 28, 29 and 41, the third reset member 330 includes two torsion springs connected to each other. Each torsion spring includes a coupling end 331, a deformation end 332, and a second collar 333 located between the coupling end 331 and the deformation end 332. The deformed ends 332 of the two torsion springs are connected to each other. A mounting pin 364 is fixed on the driving member 311. The mounting pin 364 is substantially parallel to the safety pin 362 and is located on the side of the sliding hole 3114 adjacent to the engaging element 2100. The coupling ends 331 of the two torsion springs are annular and are both sleeved on the safety pin 362. The second collars 333 of the two torsion springs are sleeved on the mounting pin 364. The deformation ends 332 of the two torsion springs and the connection portion between the two deformation ends 332 can abut against the driving member 311 to provide an elastic force for the first safety locking part and the second safety locking part to engage or push against each other. Specifically, the driving member 311 is also provided with a slot 3115 that substantially faces the sliding hole 3114. The deformation ends 332 of the two torsion springs and the connection portion between the two deformation ends 332 extend into the slot 3115 and can abut against the groove wall of the slot 3115, to provide an elastic force for the first safety locking part and the second safety locking part to engage with or push against each other.

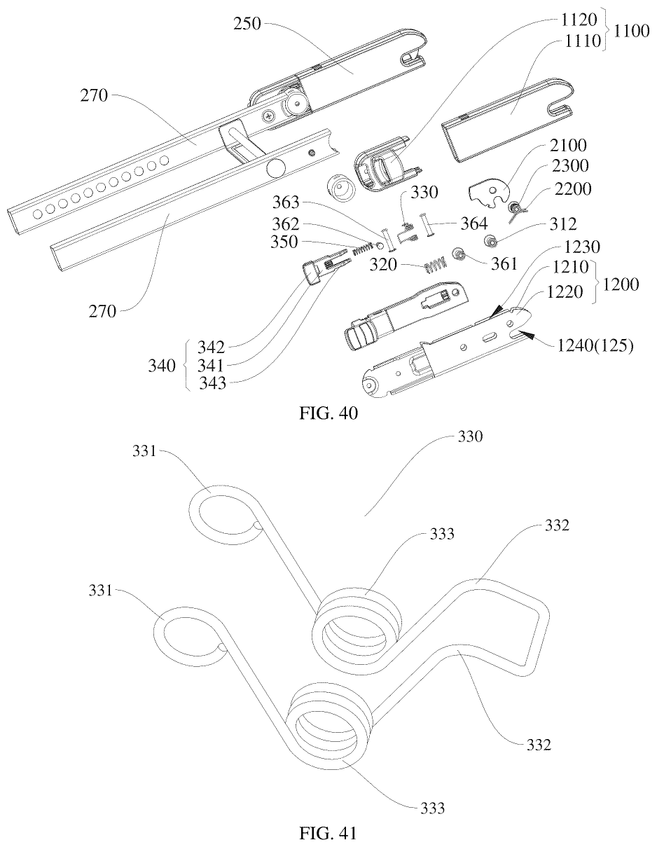

Further, as shown in FIGS. 26 to 29, the safety unlocking member 340 is movably disposed on the connecting assembly 1000 and can be switched between a second locked position and a second unlocked position. The safety unlocking member 340 is operable to move to the second unlocked position and drive the safety pin 362 to slide and separate from the retaining pin 363. The second unlocked position is closer to the engaging element 2100 than the second locked position, that is, the second locked position is located in the fourth direction D4 of the second unlocked position. Specifically, as shown in FIG. 40, the safety unlocking member 340 includes an unlocking member body 341. One end of the unlocking member body 341 protrudes toward the operating port 1122 of the second housing 1120 to form a second operating part 342. The second operating part 342 is operable to drive the safety unlocking member 340 to move. Another end of the unlocking member body 341 has a fork-shaped structure and includes two fork legs 343. The retaining pin 363 is located between the two fork legs 343. The two fork legs 343 are each provided with an inclined surface or an arc-shaped surface 3431 configured to push the safety pin 362 to slide.

Further, the fourth reset member 350 is provided between the safety unlocking member 340 and the connecting assembly 1000. The fourth reset member 350 is adapted to bias the safety unlocking member 340 to move toward the second locked position. Specifically, as shown in FIGS. 28 and 29, a second mounting protrusion 3411 is disposed on the side of the unlocking member body 341 facing the safety pin 362. The fourth returning member 350 includes a spring. One end of the fourth reset member 350 is sleeved on the second mounting protrusion 3411 and abuts against the unlocking member body 341, and another end of the fourth reset member 350 abuts against the retaining pin 363. In this way, the fourth reset member 350 can be prevented from being deflected during the biasing process.

The unlocking process of the locking mechanism 300 is described below.

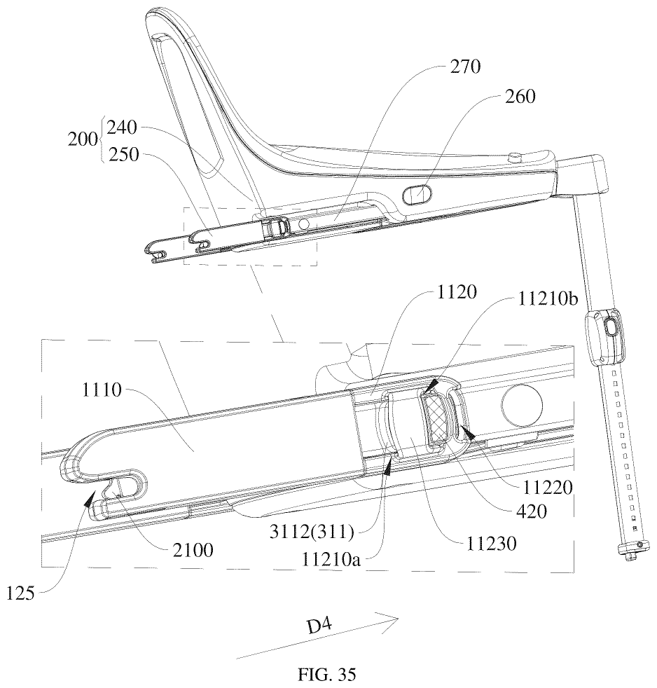

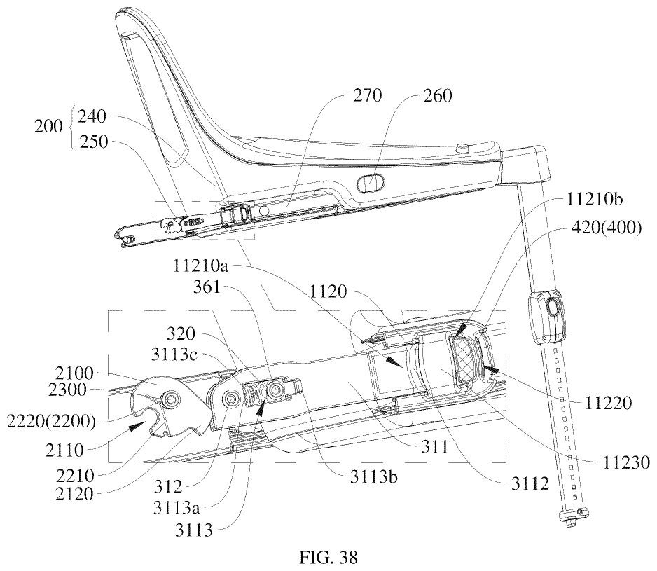

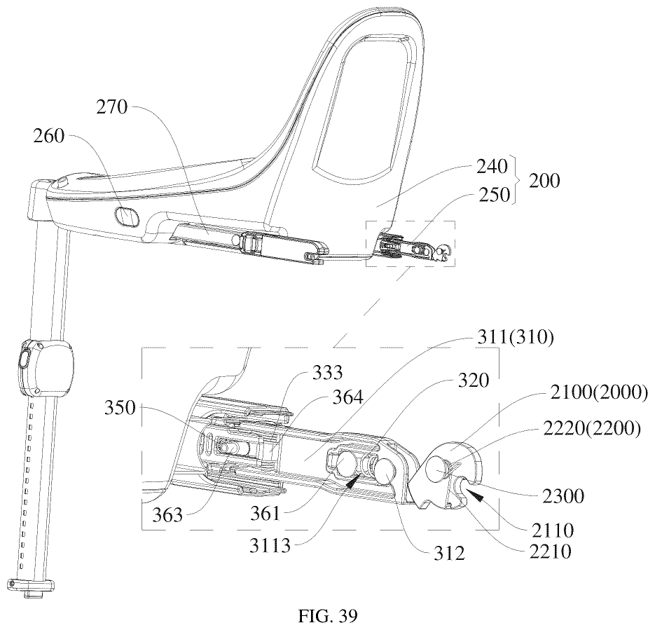

When it is required to unlock the locking mechanism 300 so that the engaging element 2100 is switched from the closed position to the opened position to be disengaged from the engaging rod, as shown in FIGS. 30 and 31, first, the second operating part 342 of the safety unlocking member 340 needs to be pushed toward the direction approaching the engaging element 2100 (i.e., in the direction opposite to the fourth direction D4), so that the safety unlocking member 340 moves from the second locked position to the second unlocked position. As shown in FIGS. 34 and 39, during the movement of the safety unlocking member 340, the inclined surfaces or arc-shaped surfaces 3431 of the two fork legs 343 push against the safety pin 362, so that the safety pin 362 moves from the first end 3114a of the sliding hole 3114 to the second end 3114b, and then, does not abut against the retaining pin 363 or is not hindered by the retaining pin 363. As shown in FIGS. 30 and 35, the first operating part 3112 of the driving member 311 can be pushed in a direction away from the engaging element 2100 (i.e., in the fourth direction D4), so that the driving member 311 moves from the first locked position to the first unlocked position. As shown in FIGS. 33 and 38, during the movement, the driving member 311 drives the limiting pin 312 fixedly connected thereto to move in a direction away from the engaging element 2100 (i.e., in the fourth direction D4) and is disengaged from the limiting part 2120. The engaging element 2100, which is not pushed by the limiting pin 312, pivots from the closed position to the opened position under the elastic force of the first reset member 2200, so that the engaging groove 2110 of the engaging element 2100 is disengaged from the engaging rod, allowing the child carrier 1 to be removed from the vehicle seat.

Further, as shown in FIG. 26, when the locking mechanism 300 is in the locked state and the safety unlocking member 340 is not operated, that is, the driving member 311 is in the first locked position, and the safety unlocking member is in the second locked position, there is an idle stroke L between the driving member 311 and the retaining pin 363. When the driving member 311 is operated to move within the idle stroke L, the limiting pin 312 and the limiting part 2120 push against each other, and the safety unlocking member 340 and the safety pin 362 are spaced apart. In this way, when the first operating part 3112 of the driving member 311 is accidentally touched, if the moving stroke of the driving member 311 is within the idle stroke L, the limiting pin 312 will not be separated from the limiting part 2120, and the safety pin 362 will not be pushed by the inclined surface or arc-shaped surface 3431 of the safety unlocking member 340 to move. In addition, when the second operating part 342 of the safety unlocking member 340 is accidentally touched, if the moving stroke of the safety unlocking member 340 is within the idle stroke L, the limiting pin 312 will not be separated from the limiting part 2120, and the safety pin 362 will not be pushed by the inclined surface or arc-shaped surface 3431 of the safety unlocking member 340 to move to cause the driving member 311 to be unlocked. In this way, the safety of the fixing device 250 can be further guaranteed, and the damage to the first operating part 3112 caused by accidental touch and rigid touch after the accidental touch can be reduced.

Further, as shown in FIGS. 30, 31, 35 and 36, the fixing device 250 may further include an indication assembly 400 for indicating the state of the locking mechanism 300. The indication assembly 400 includes at least a first indication identifier 410 configured to indicate that the locking mechanism 300 is in the locked state and a second indication identifier 420 configured to indicate that the locking mechanism 300 is in the unlocked state. In this embodiment, the first indication identifier 410 includes a green indicator, and the second indication identifier 420 includes a red indicator. In other embodiments, the first indication identifier 410 and the second indication identifier 420 may also include indicator bars of different shapes or patterns.

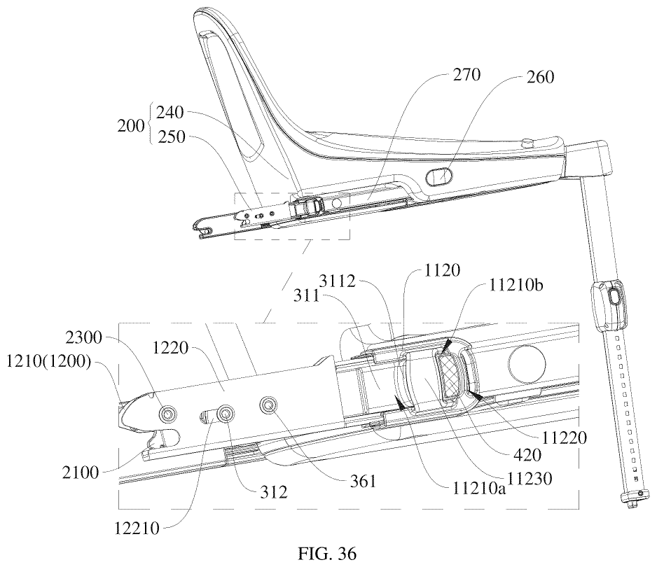

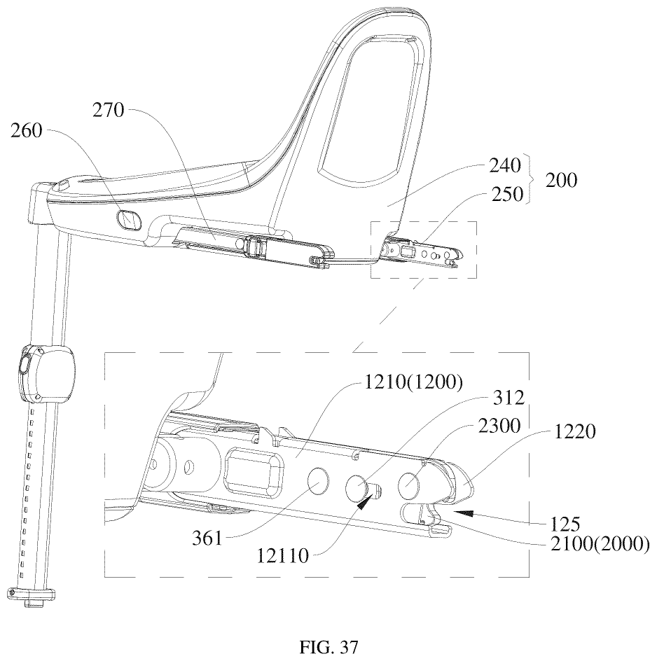

The first indication identifier 410 and the second indication identifier 420 are spaced apart at one end of the driving member 311 away from the engaging element 2100. In this embodiment, the first indication identifier 410 and the second indication identifier 420 are spaced apart on the first operating part 3112 of the driving member 311. The first display window 11210a on the second housing 1120 is closer to the engaging element 2100 than the second display window 11210b, that is, the second display window 11210b is located in the fourth direction D4 of the first display window 11210a. The second housing 1120 is provided with a shielding member 11230 located between the first display window 11210a and the second display window 11210b. When the driving member 311 is located at the first locked position, as shown in FIGS. 30 and 31, the first indication identifier 410 is displayed in the first display window 11210a, and the second indication identifier 420 is shielded by the shielding member 11230. That is, the first operating part 3112 displays the green indicator, so that the user can know that the locking mechanism 300 is in the locked state. As shown in FIGS. 35 and 36, when the driving member 311 is located in the first unlocked position, the second indication identifier 420 is displayed in the second display window 11210b, and the first indication identifier 410 is shielded by the shielding member 11230. That is, the first operating part 3112 displays the red indicator, so that the user can know that the locking mechanism 300 is in the unlocked state.

The fixing device 250, the base 200 and the child carrier 1 in the present application have at least the following technical effects.

The above-mentioned fixing device 250 of the child carrier 1 is connected to the base body 240 through its connecting assembly 1000. The connecting assembly 1000 is provided with the engagement mechanism 2000 and the locking mechanism 300. The engaging element 2100 in the locking mechanism 300 is pivotally connected to the connecting assembly 1000 and is pivotable between the opened position and the closed position. When the engaging element 2100 is in the closed position, the engaging element 2100 can be engaged with the engaging rod of the vehicle seat, thereby connecting the base 200 (or the child carrier 1) to the vehicle seat. The first reset member 2200 is adapted to bias the engaging element 2100 to move toward the opened position. The locking mechanism 300 is switchable between the locked state in which the engaging element 2100 is locked in the closed position and the unlocked state in which the engaging element 2100 is unlocked. In this way, when the locking mechanism 300 is in the unlocked state, the engaging element 2100 will be automatically switched to the opened position under the action of the first reset member 2200, so that the unlocking can be performed conveniently and smoothly, and the error locking of the engaging element 2100 will not easily occur. The fixing device 250 of the present application has a simple structure, is easy to manufacture, has low cost and is convenient to operate.

The technical features of the embodiments described above may be combined arbitrarily. For the sake of brevity, not all possible combinations of the technical features in the embodiments are described. However, as long as there is no contradiction between the combinations of the technical features, they shall be considered as the scope of the specification.

The above-described embodiments are only some embodiments of the present application, and their description is more specific and detailed, but cannot be understood as a limitation on the scope of the application. It should be noted that, for a person of ordinary skill in the art, several modifications and improvements may be made without departing from the concept of the present application, which are within the protection scope of the present application. Therefore, the scope of protection of this patent application shall be subject to the appended claims.

1. A child carrier, comprising:
a base;
a seat assembly rotatably disposed on the base; and
a rotation angle adjustment mechanism, wherein the rotation angle adjustment mechanism comprising:
a limiting member disposed on the base; and
a pushing member disposed on the seat assembly and rotatable relative to the base along with the seat assembly;
wherein when the seat assembly is rotated such that the pushing member is located within a specified angle range, the limiting member drives the pushing member to rotate towards a position in a predetermined direction; and
wherein when the pushing member is located in the predetermined direction, the limiting member locks the pushing member in the predetermined direction, so that the seat assembly is limited to a preset use mode.

2. The child carrier of claim 1, wherein the limiting member is provided with a limiting recess, the pushing member has an engaging end, and
when the pushing member is located in the predetermined direction, the engaging end is engaged with the limiting recess.

3. The child carrier of claim 2, wherein the rotation angle adjustment mechanism further comprises:
an elastic reset member adapted to provide elastic restoring force to the pushing member to cause the pushing member to push against the limiting member;
wherein the limiting member is provided with a guide surface defining the specified angle range; and
wherein the pushing member is movably disposed on the seat assembly and is provided with a pushing surface adapted to cooperate with the guide surface.

4. The child carrier of claim 3, wherein the elastic reset member includes a compression spring.

5. The child carrier of claim 3, wherein two of the pushing members are provided, and are symmetrically disposed on the seat assembly, and two ends of the elastic reset member respectively abut against the two pushing members.

6. The child carrier of claim 1, wherein the base is provided with an insertion hole, and the seat assembly comprises a seat body and a fixing cover;
wherein the fixing cover is at least partially inserted into the insertion hole and connected to the seat body, so that the seat body is rotatable around a rotation axis relative to the base together with the fixing cover; and
wherein the pushing member is disposed on the fixing cover.

7. The child carrier of claim 6, wherein the fixing cover is provided with a sliding groove, the pushing member is provided in the sliding groove and is slidable along the sliding groove; and
wherein at least a portion of the pushing member is capable of extending out of the sliding groove to be engaged with the limiting member.

8. The child carrier of claim 6, wherein one of the fixing cover and the pushing member is provided with a stroke groove, and another of the fixing cover and the pushing member is provided with a limiting protrusion, the limiting protrusion being inserted into the stroke groove.

9. The child carrier of claim 8, wherein the rotation angle adjustment mechanism further comprises a fastener that at least partially extends through the stroke groove and is connected to the limiting protrusion.

10. The child carrier of claim 3, wherein a moving direction of the pushing member is perpendicular to a rotation axis of the seat assembly, and the pushing member or an extension line of the pushing member extends through the rotation axis.

11. The child carrier of claim 3, wherein the limiting member further comprises a slope surface connected to a side of the guide surface away from the limiting recess and gently transitioning to the guide surface; and
wherein when the pushing member is in contact with the slope surface, the elastic reset member is in an energy storage state.

12. The child carrier of claim 11, wherein a distance between any point on the slope surface and the rotation axis is less than a distance between a point on the limiting recess that is farthest from the rotation axis and the rotation axis.

13. The child carrier of claim 11, wherein the limiting member is further provided with a lifting surface, two sides of the lifting surface being respectively connected to the slope surface and the guide surface.

14. The child carrier of claim 3, wherein the limiting member is further provided with a driving surface; and
wherein the driving surface and the guide surface are respectively disposed on two sides of the limiting recess.

15. The child carrier of claim 14, wherein the driving surface and the guide surface are symmetrically disposed on the two sides of the limiting recess.

16. The child carrier of claim 3, wherein the limiting member comprises at least two limiting recesses, and the number of the limiting recesses is an integer multiple of the number of the pushing members.

17. The child carrier of claim 1, wherein the seat assembly comprises a seat body and at least one buffer body disposed on the seat body, wherein:
the buffer body comprises a plurality of buffer blocks, and a buffer gap is formed between two adjacent buffer blocks;
the seat body comprises a headrest part and side parts located at two sides of the headrest part, and the headrest part and the side parts each are provided with the buffer body.

18. The child carrier of claim 1, further comprising:
a rotatable engaging mechanism disposed on the seat assembly;
wherein the base is provided with an engaging hole, and the rotatable engaging mechanism is capable of being engaged with the engaging hole to lock the seat assembly in the preset use mode.

19-38. (canceled)
